(19) United States
(12) Patent Application Publication
(10) Pub. No.: US 2014/0351709 A1
(43) Pub. Date: Nov. 27, 2014

(54) INFORMATION PROCESSING DEVICE HAVING INFORMATION MANAGEMENT EDITING FUNCTION

(71) Applicants: Hiroyuki Uno, Kanagawa (JP); Eiko Yamada, Kanagawa (JP)

(72) Inventors: Hiroyuki Uno, Kanagawa (JP); Eiko Yamada, Kanagawa (JP)

(73) Assignee: NEC CASIO MOBILE COMMUNICATIONS, LTD., Kanagawa (JP)

(21) Appl. No.: 14/344,881

(22) PCT Filed: Sep. 10, 2012
(86) PCT No.: PCT/JP2012/073015

§ 371 Date: Mar. 13, 2014

(30) Foreign Application Priority Data
Sep. 16, 2011 (JP) 2011-202865

(51) Int. Cl. G06F 3/0484; G06F 3/0488

(52) U.S. Cl. CPC G06F 3/04842; G06F 3/0488
USPC 715/747

(57) ABSTRACT

An information processing device, having a touch panel, which achieves an information processing function interacting with a user's operation includes a display which display an operation screen, an operation part which receives a user's operation on the operation screen, an information acquisition part which acquires specific information from an display object area on the operation screen, and an information management part which manages specific information in connection with a desired attribute which is set by a user in advance. Additionally, the information processing device further includes a display control part, which displays a specific information operation area and an attribute operation area on the operation screen, and an operation content determination part which determines the content of a user's operation. Moreover, the information processing device may achieve a process to easily create a database using specific information in response to a user's operation.

### TECHNICAL FIELD

The present invention relates to an information processing device having a touch panel and in particular to an information processing device having an information management editing function.

The present application claims priority on Japanese Patent Application No. 2011-202865 filed Sep. 16, 2011, the entire content of which is incorporated herein by reference.

### BACKGROUND ART

Recently, portable terminals such as smart phones and tablet terminals have been widely spread. Portable terminals having touch panels allow users to touch and operate icons displayed on operation screens, thus implementing arbitrary functions. Using touch panels, it is possible for users to easily and intuitively operate portable terminals.

Patent Literature Document 1 discloses a personal finance input support system in which a receipt image, which a user captures with a portable information terminal, is transmitted to a server which in turn produces personal finance data based on the receipt image so as to send it to the portable information terminal. Patent Literature Document 2 discloses an input device which allows each user to apply touch operations to a touch panel with a plurality of user's fingers concurrently and which allows each user to concurrently select and operate a plurality of objects such as icons with one hand. Patent Literature Document 3 discloses a screen operation method which allows each user to implement a plurality of operation modes with a plurality of files via simple procedures when each user copies files with a PC, a portable device, or a TV receiver, each user moves files to folders or storage media, or each user reads files. Patent Literature Document 4 discloses a portable electronic device having a multi-touch input function which executes processing on a plurality of objects based on multi-touch operations.

Additionally, various services have been provided to users of portable terminals. Patent Literature Document 1 discloses a personal finance preparation support service which manages information, which a user acquires with a portable terminal, via a server. That is, a receipt image, which a user captures with a portable terminal, is transmitted to a server which in turn analyzes the receipt image and extracts information so as to prepare personal finance data. Thereafter, the server provides personal finance data to the portable terminal. In the personal finance input support system, the server extracts all the recognizable character information among characters included in the receipt image so as to prepare personal finance data in connection with information representing dates, names of goods, and prices.

Users who intends to prepare personal finances may employ a thousands ways of information management methods. For example, some users may prefer to meticulously manage all items of purchased goods; some users may prefer to solely manage goods of food categories among purchased goods; some users may prefer to solely manage total payments for each store or for each receipt. Additionally, some users may prefer to collectively manage all the goods of food categories among purchased goods; some users may prefer to manage goods by further diversifying food categories into fresh goods and beverages.

### CITATION LIST

### Patent Literature Document

Patent Literature Document 1: Japanese Patent Application Publication No. 2005-135000

Patent Literature Document 2: Japanese Patent Application Publication No. 2000-222130

Patent Literature Document 3: Japanese Patent Application Publication No. 2008-90361

Patent Literature Document 4: Japanese Patent Application Publication No. 2009-522669

### SUMMARY OF INVENTION

### Technical Problem

In the personal finance input support system of Patent Literature Document 1, each user needs to edit personal finance data prepared by a server in accordance with a certain management method preferred by each user. However, all the pieces of information acquired by each user are input to personal finance data, and therefore a server may automatically manage the information, which each user does not prefer to register in personal finances. When each user prefer to select the information, which needs to be managed in personal finances, so as to input the information to a computer by use of a keyboard or a mouse, user's input operations must be complicated so as to cause input errors; this is inconvenient for each user.

The present invention is made in consideration of the aforementioned problem, wherein it is an object of the invention to provide an information processing device having an information management editing function in consideration of usability.

### Solution to Problem

The present invention is directed to an information processing device having a touch panel, which includes a display which displays an operation screen; an operation part which receives a user's operation on the operation screen; an information acquisition part which acquires specific information from a display object area on the operation screen; and an information management part which manages specific information in connection with a desired attribute which is set by a user in advance.

The present invention is directed to an information processing device having a touch panel, which includes a display which displays the operation screen; an operation part which receives a user's operation on the operation screen; a display control part which controls the display to display on the operation screen a specific information operation area, which receives a user's operation to specify desired specific information, an input operation area, which receives a user's operation to input information, and an attribute operation area which receives a user's operation to set a desired attribute; an operation content determination part which determines the content of a user's operation based on the detection result of a user's operation on the operation screen with the operation part; and an information input part which posts specific information in the input operation area when the desired specific information is specified via a user's operation in the specific information operation area while a user's operation to input information is applied to the input operation area.

The present invention is directed to an information processing method adapted to an information processing device having a touch panel, which includes the steps of: receiving a user's operation on an operation screen which is displayed on the touch panel; acquiring specific information from a display object area on the operation screen; and when a desired attribute is set by a user in advance, managing the specific information in connection with the attribute.

The present invention is directed to a program adapted to a computer achieving an information processing function interacting with a user's operation, which controls the computer to implement the steps of: receiving a user's operation on an operation screen; acquiring specific information from a display object area on the operation screen; and when a desired attribute is set by a user in advance, managing the specific information in connection with the attribute.

### Advantageous Effects of Invention

The present invention implements user's control interlocking types of information processing programs, such as personal finance information acquisition applications, personal finance management applications, text editing applications, and search applications, with an information processing device such as a portable terminal, which is designed to manage user's specified information (e.g. the amount of payment for each item of payment) in connection with predetermined attributes (e.g. items of payment for each category of personal finance data) with simple user's operations (e.g. touch operations, touch-slide operations, flick operations). Additionally, it is possible to produce database based on management information such as personal finance data with simple user's operations.

### BRIEF DESCRIPTION OF DRAWINGS

FIG. 1 is a configuration diagram showing an information processing system including a portable terminal according to a first embodiment of the present invention.

FIG. 2 is a block diagram of the portable terminal according to the first embodiment of the present invention.

FIG. 3 is a table showing an example of the stored content of a specific information database which is stored in a store part of the portable terminal according to the first embodiment of the present invention.

FIG. 4 is an enlarged front view showing an example of an information reception screen which is displayed on a touch panel of the portable terminal according to the first embodiment of the present invention.

FIG. 5 includes enlarged front views showing a procedure to capture a logo mark of a store from the captured image of a receipt with the touch panel of the portable terminal according to the first embodiment of the present invention.

FIG. 6 includes a procedure to capture the amount of payment for a desired item of payment from the captured image of a receipt with the touch panel of the portable terminal according to the first embodiment of the present invention.

FIG. 7 includes enlarged front views showing a procedure subsequent to the procedure shown in FIG. 6 on the touch panel of the portable terminal according to the first embodiment of the present invention.

FIG. 8 includes enlarged front views showing animation images which are displayed on the information reception screen when a user specifies a display object so as to input specific information on the touch panel of the portable terminal according to the first embodiment of the present invention.

FIG. 9 is a flowchart showing a basic process of the portable terminal according to the first embodiment of the present invention.

FIG. 10 is a flowchart sowing a database process of specific information in the portable terminal according to the first embodiment of the present invention.

FIG. 11 is an enlarged front view showing an information reception screen which is displayed on the touch panel of a portable terminal according to a second embodiment of the present invention.

FIG. 12 includes enlarged front views showing a text editing procedure in the portable terminal according to the second embodiment of the present invention.

FIG. 13 is a flowchart showing a basic process of the portable terminal according to a second embodiment of the present invention.

FIG. 14 is an enlarged front view showing an information reception screen which is displayed on the touch panel of the portable terminal according to a third embodiment of the present invention.

FIG. 15 includes enlarged front views showing a user's procedure to execute a search process with the portable terminal according to the third embodiment of the present invention.

FIG. 16 is a block diagram of a portable terminal according to a fourth embodiment of the present invention.

FIG. 17 is an enlarged front view showing an information reception screen which is displayed on the touch panel of the portable terminal according to the fourth embodiment of the present invention.

FIG. 18 includes enlarged front views showing a user's procedure to execute a search process with the portable terminal according to the fourth embodiment of the present invention.

FIG. 19 is a flowchart showing a basic process of the portable terminal according to the fourth embodiment of the present invention.

### DESCRIPTION OF EMBODIMENTS

An information processing device according to the present invention will be described in detail with reference to the accompanying drawings.

### First Embodiment

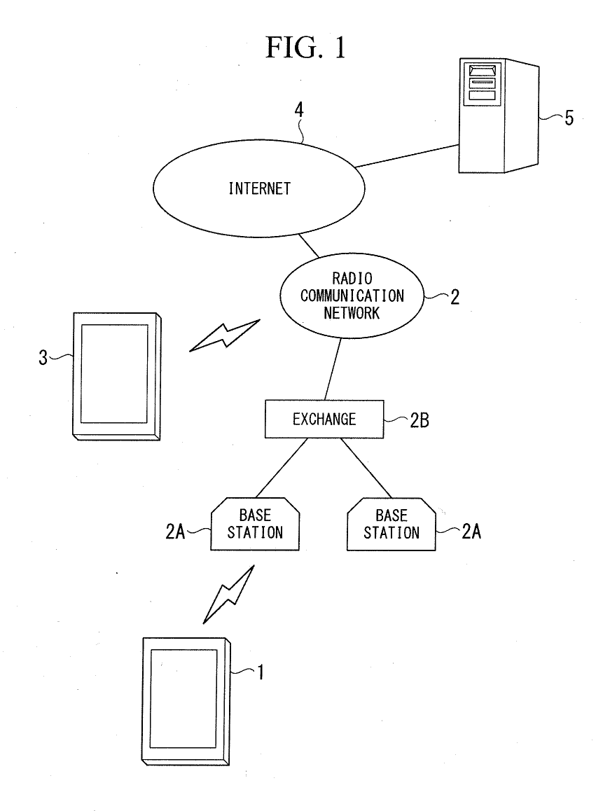

FIG. 1 shows a communication network system (or an information processing system) to which a portable terminal 1 according to the first embodiment of the present invention is connected. The information processing device of the present invention is not necessarily limited to the portable terminal 1; hence, the present invention can be embodied via smart phones, portable game devices, PDA (Personal Digital Assistant), tablet PC (Personal Computer), or note-type PC. For example, the portable terminal 1 may include a call function, an electronic mail function, an Internet-connecting function (or a Web-accessing function), and a digital television broadcasting function (e.g. one-segment terrestrial digital television broadcasting function).

When the portable terminal 1 is connected to a radio communication network (or a mobile communication network) 2 via a nearby base station 2A and an exchange 2B, the portable terminal 1 is able to communicate with another portable terminal 3 via the radio communication network 2. When the portable terminal 1 is connected to the Internet 4 via the radio communication network 2, the portable terminal 1 is able to access a Web site so as to enable a browsing function. Additionally, the portable terminal 1 is able to implement streaming transmission to download and reproduce multimedia contents such as moving images, still images, music, and news from a server 5 via the radio communication network 2 or the Internet 4.

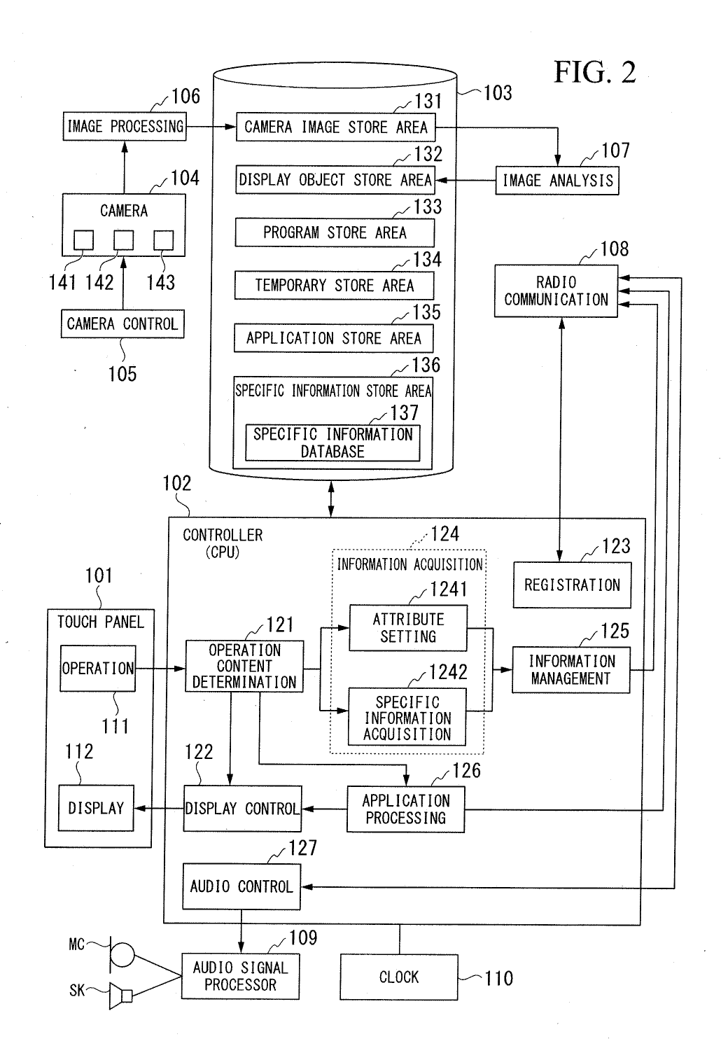

FIG. 2 is a block diagram showing the basic configuration of the portable terminal 1. The portable terminal 1 includes a touch panel 101, a controller 102, a store part 103, a camera 104, a camera control part 105, an image processing part 106, an image analysis part 107, a radio communication part 108, an audio signal processor 109, and a clock 110. A plurality of processing modes is set to the portable terminal 1. In an image-capturing mode, the portable terminal 1 starts the camera 104 to capture an object so as to obtain image data. In a database mode, the portable terminal 1 acquires user's specific information from the image captured by the camera 104 so as to write the specific information in the store part 103 in connection with attribute information indicating attributes.

An image-capturing mode is set to the portable terminal 1 in accordance with a personal finance image acquisition application app1, wherein when the camera 104 captures a desired image, the processing mode is switched to the database mode. That is, the personal finance information acquisition application app1 is an application to acquire specific information for each attribute in order to prepare personal finances. The present embodiment refers to the processing of the portable terminal 1 in accordance with the personal finance information acquisition application app1 which is downloaded from the server 5; but this is not a restriction. The program of the personal finance information acquisition application app1 may be pre-installed in the portable terminal 1.

A user captures a receipt with the camera 104 of the portable terminal 1 so as to display the information such as a store name, names of goods, and payments described on the receipt on the touch panel 101. When the portable terminal 1 activates the personal finance information acquisition application app1 to acquire the information which is used to prepare personal finances, the captured receipt image and attributes icons indicating attributes (e.g. a store name, food, sundry goods, lighting and fuel) which are determined in advance via the personal finance information acquisition application app1 are concurrently displayed on the touch panel 101. When a user touches one of attribute icons so as to slide an area displaying the information such as a store name, names of goods, and payments within the receipt image, the portable terminal 1 writes the specific information of the slid area in the store part 103 in connection with the attribute of the touched attribute icon. Thus, the portable terminal 1 correlates the specific information, indicating the slid area, to the attribute of an attribute icon touched by a user. Since a user carry out a touch operation and a slide operation concurrently, the portable terminal 1 may acquire the attribute information and the specific information; but this is not a restriction. For example, a user may carry out a touch operation on an attribute icon on the touch panel 101 so as to specify an attribute; thereafter, a user may release the touch operation and then carry out a slide operation on a desired area to indicate specific information. Additionally, an operation to indicate attribute information and an operation to indicate specific information are not necessarily limited to a touch operation and a slide operation; hence, those operations can be implemented using other types of user's operations.

Next, the constituent elements of the portable terminal 1 will be described. The touch panel 101 includes an operation part 111 and a display 112. The operation part 111 includes a sensor to receive a user's operation, thus outputting the detection result of a sensor to the controller 102. That is, the operation part 111 detects the touch position of a user's finger on the operation screen for each time interval with a sensor, thus outputting the detection result of a sensor to the controller 102. This is not limitation. For example, it is possible to detect the position of a user's finger or an operation indicting means (a stylus pen) approaching the operation screen with a non-touch sensor. The operation part 111 receives a user's operation via the operation screen which is displayed on the display 112. The operation part 111 is integrally manufactured with the display 112 configuring the touch panel 101; hence, the display screen of the display 112 matches the operation screen of the operation part 111. The display 112 displays the operation screen to receive a user's operation on the operation part 111. The display 112 displays an image, which is captured by the camera 104, on the operation screen. The captured image displayed on the operation screen includes display objects such as characters and figures. That is, the display 112 displays a display object specified by a user on the operation screen.

The controller 102 reads various pieces of information stored in the store part 103 so as to totally control the portable terminal 1. The controller 102 includes an operation content determination part 121, a display control part 122, a registration part 123, an information acquisition part 124, an information management part 125, an application processing part 126, and an audio control part 127.

The display content determination part 121 determines an operation content received by the operation part 111 based on the output of the operation part 111. For example, determines the movement of a user's finger on the touch panel 101 based on the detection result of the operation part 111 indicating the touch position and the touch time of a user's finger. The operation content determination part 121 determines the operation content specified by the movement of a user's finger based on the movement of a user's finger and the positional relationship with an image which is displayed on the display 112 in a mode to receive a user's operation. For example, when the operation part 111 detects a user's finger touching the operation screen, the operation content determination part 121 determines that a user's operation is a touch operation. Additionally, when the operation part 111 detects that a user moves a user's finger while touching the operation screen, the operation content determination part 121 determines that a user's operation is a slide operation. When the operation part 111 detects that a user shakes off a user's finger while rubbing the operation screen, the operation content determination part 121 determines that a user's operation is a flick operation.

The operation content determination part 121 may determine an operation content received by the operation part 111 based on time information clocked by the clock 110. When a user continuously touches part of the operation screen for the predetermined time or more, the operation content determination part 121 may determine that a user's operation is an operation to specify an area. The area specifying operation is a user's operation which specifies a display object area encompassing a display object at the touch position of a user's finger. For example, when an image representing characters or numbers (i.e. a display object) is tied with text data representing characters or numbers in connection with an image displayed on the operation screen, a display object area indicates an area encompassing an image representing characters or numbers on the operation screen. When a user continuously touches part of a display object area showing characters or numbers (i.e. a display object) on the operation screen, the operation content determination part 121 determines that a user specifies text data such as characters or figures encompassed by the display object area.

The operation content determination part 121 instructs the display control part 122 to display the display content corresponding to a user's operation on the display 112. For example, upon determining that a user's operation is a touch operation, the operation content determination part 121 controls the display control part 122 such that an icon image corresponding to the touch position of a user's finger will be displayed and superposed on the operation screen. The display control part 122 displays a finger icon representing the touch position of a user's finger on the display 112. Additionally, the display control part 122 displays a plurality of finger icons representing the positions of a plurality of user's fingers on the operation screen of the touch panel 101. Additionally, the display control part 122 controls the display content of the display 112 based on the determination result of the operation content determination part 121 indicating a user's operation.

The registration part 123 registers data, which the radio communication part 108 receives from the server 5 via the Internet 4, in the store part 103. For example, the registration part 123 downloads various applications, which need to be installed in the portable terminal 1, from the server 5 so as to store them in the store part 103.

The information acquisition part 124 acquires specific information as a display object corresponding to the user's specified position on the operation screen within display objects displayed on the operation screen of the touch panel 101. The information acquisition part 124 includes an attribute setting part 1241 which is used to set an attribute of specific information specified by a user based on the determination result of the operation content determination part 121, and a specific information acquisition part 1242 which acquires the specific information from the stored information of the store part 103.

When the operation content determination part 121 detects a user's touch operation on the operation screen, the attribute setting part 1241 determines the attribute of an attribute icon specified by a touch operation based on the user's touch position on the operation screen. The attribute setting part 1241 sets the attribute of an attribute icon as the attribute of specific information specified by a user based on the determination result. In the present embodiment, the attribute setting part 1241 may set a single attribute.

When the operation content determination part 121 detects a user's touch operation, the specific information acquisition part 1242 determines as to whether or not a user carries out a slide operation on the operation screen including a display object. For example, when an image captured by the camera 104 is displayed on the operation screen of the touch panel 101, the specific information acquisition part 1242 determines as to whether or not a user carries out a slide operation on the operation screen displaying the captured image. The specific information acquisition part 1242 detects a display object area specified by a user's slide operation based on the detected position of the user's slide operation on the operation screen. When the display object area is detected by the user's slide operation, the specific information acquisition part 1242 acquires the specific information corresponding to the display object area.

When the specific information acquisition part 1242 acquires specific information on the condition that an attribute is set to the specific information, the information management part 125 manages the specific information acquired by the specific information acquisition part 1242 in connection with the attribute which is set by the attribute setting part 1241. Additionally, the information management part 125 writes the specific information acquired by the specific information acquisition part 1242 in a specific information database 137 in connection with the attribute which is set by the attribute setting part 1241. Moreover, the information management part 125 sets an additional flag when the information management part 125 writes the specific information correlated to the predetermined attribute information in the specific information database 137 at first, in other words, when the information management part 125 correlates the desired specific information to the predetermined attribute information so as to write them in the specific information database 137 on the condition that no specific information is correlated to the predetermined attribute information. In this connection, the information management part 125 may manage and store the specific information acquired by the specific information acquisition part 1242 in an external storage medium or storage device in connection with the attribute which is set by the attribute setting part 1241.

The application processing part 126 reads an application stored in a application store area 135 so as to execute the application program based on the determination result of the operation content determination part 121. For example, when a user inputs an instruction to start the personal finance information acquisition application app1 with the operation part 111, the application processing part 126 reads and executes the program of the personal finance information acquisition application app1 from the application store area 135. The application processing part 126 executes the process of an image-capturing mode according to the personal finance information acquisition application app1, and then carries out the process of a database mode when successfully acquiring image data. When a user inputs an instruction to start the personal finance management application app2 with the operation part 111, the application processing part 126 reads and executes the program of the personal finance management application app2 from the application store area 135. The application processing part 126 processes the information written in the specific information database 137 in accordance with the personal finance management application app2, thus updating user's personal finance data which is stored in advance. In this connection, the application processing part 126 may update personal finance data which is stored in an external storage medium or storage device.

The audio control part 127 transmits digital audio data, which is input thereto from the audio signal processor 109, to the other portable terminal 3 via the radio communication part 108. Additionally, digital audio data is input from the other portable terminal 3 and then output to the audio signal processor 109. The store part 103 stores various pieces of information which are used for the processing of the portable terminal 1. The store part 103 includes a camera image store area 131, a display object store area 132, a program store area 133, a temporary store area 134, the application store area 135, and a specific information store area 136. For example, the store part 103 may embrace SD cards, IC cards, and detachable portable memory devices (recording media) such as external hard-disk units. Alternatively, the store area 103 may be installed in a predetermined external server (not shown).

The camera image store area 131 is a store area to store an image captured by the camera 104. The camera image store area 131 stores image data which is processed by the image processing part 106. The display object store area 132 is an area to store display objects (e.g. text data and schematic data), which are extracted from images captured by the camera 104 in connection with positional information representing the positions in the captured images. The program store area 133 is an area to store programs and various applications which are used to implement the processing of the present embodiment in response to various processes applied to the portable terminal 1 by a user. The temporary store area 134 is an area to temporarily store various pieces of information which are necessary for the portable terminal 1 to operate. The application store area 135 is an area to store application programs installed in the portable terminal 1. For example, the application store area 135 stores the personal finance information acquisition application app1 and the personal finance management application app2.

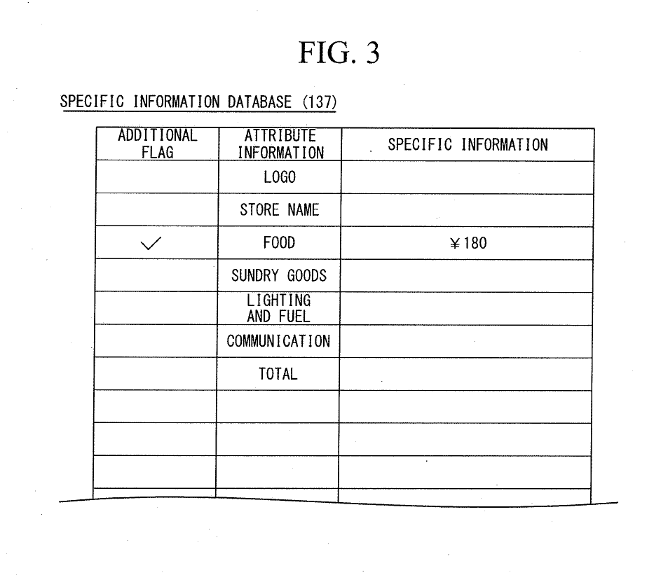

The specific information store area 136 is an area to store the specific information database 137 which stores specific information, acquired by the information acquisition part 124 of the controller 102, in connection with attribute information. FIG. 3 shows an example of the stored content of the specific information database 137. The specific information database 137 is a table to store additional flags, attribute information, and specific information in connection with each other. Additional flags indicate that specific information has been already written in the specific information database 137 in connection with attribute information. Specific information is acquired by the specific information acquisition part 1242 of the information acquisition part 124. Attribute information is set by the attribute information setting part 1241 when the specific information acquisition part 1242 acquires specific information. In FIG. 3, specific information “¥180” is written in the specific information database 137 in connection with the attribute “foods”.

Returning back to FIG. 2, the descriptions regarding the constituent elements of the portable terminal 1 will be continued below. The camera 104 includes an optical system 141, an image pickup device 142, and an A/D converter 143. The image pickup device 142 generates an image signal based on an optical image which is incident on the optical system 141. The A/D converter 143 carries out analog/digital conversion on an image signal output from the image pickup device 142 so as to generate image data. When a power switch (not shown) is operated, the camera 104 generates a series of image data based on optical images incident on the optical system 141, thus outputting them to the image processing part 106. The portable terminal 1 displays a live view on the display 112 of the touch panel 101 based on a series of image data. When a shutter button displayed on the operation screen of the operation part 111 is operated by a user, the camera control part 105 controls the camera 104 to capture desired image data based on optical images incident on the optical system 141. In this connection, it is preferable that a captured image have higher picture quality than a live view. The image processing part 106 executes an image process on image data output from the camera 104 so as to save the processed image data in the camera image store area 131 of the store part 103.

The image analysis part 107 reads image data from the camera image store area 131 so as to extract display objects (i.e. text data and schematic data) from image data. The image analysis part 107 recognizes and extracts characters and numbers resembling the text patterns including characters and numbers which are determined in advance. Additionally, the image analysis part 107 recognizes and extracts logo marks and images of goods resembling the schematic patterns including logo marks and images of goods which are determined in advance. The image analysis part 107 determines the image area, in which a display object is extracted from the captured image, as a display object area, which is then tied with the display object. For example, the image analysis part 107 correlates the positional information of a display object area on a captured image with a display object extracted from the display object area with reference to the coordinate values of XY coordinates representing the positions of pixels included in the captured image.

Upon activating a call function, an electronic mail function, or an Internet-connection function, the radio communication part 108 receives or transmits data with the nearby base station 2A via an antenna. A microphone MC and a speaker SK are connected to the audio signal processor 109. The audio signal processor 109 carries out A/D conversion on an analog audio signal, which is input thereto from the microphone MC, so as to output digital audio data to the audio control part 127. Additionally, the audio signal processor 109 carries out D/A conversion on digital audio data, which is input thereto from the audio control part 127, so as to output an analog audio signal to the speaker SK. The clock 110 outputs a clock signal for each time interval.

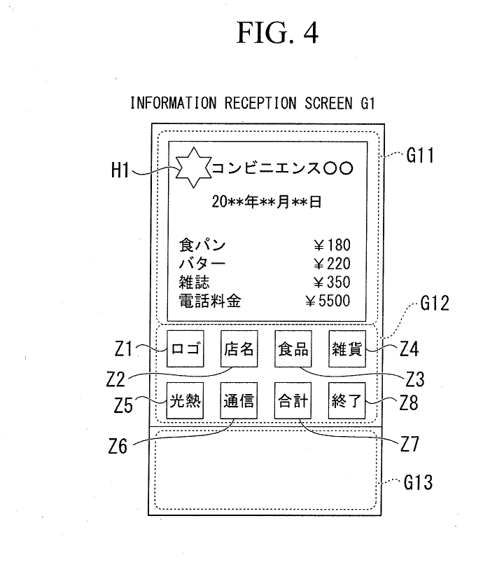

Next, an example of the operation of the portable terminal 1 will be described with reference to FIGS. 4 to 8. FIG. 4 shows an information reception screen G1 which is displayed on the display 112 of the touch panel 101 when a user starts the personal finance information acquisition application app1. The information reception screen G1 is displayed on the operation screen due to the execution of the program of the personal finance information acquisition application app1, for example, when a user captures a receipt with the camera 104 in an image-capturing mode, and then proceeds with a database mode. As shown in FIG. 4, the information reception screen G1 includes a specific information operation area G11 to display an image which is captured by a user with the camera 104, an attribute operation area G12 to display attribute icons Z1 to Z8 by which a user may specify attributes, and a capture data display area G13 to display the predetermined specific information for each attribute. The predetermined specific information is specific information which is selected by a user on the condition that a user has selected an attribute and which is written in the specific information database 137 via the information management part 125. The specific information operation area G11 is displayed in the upper portion of the operation screen of the display 112 while the capture data display area G13 is displayed in the lower portion of the operation screen. The attribute operation area G12 is displayed in the intermediate portion of the operation screen and interposed between the specific information operation area G11 and the capture data display area G13.

The specific information operation area G11 displays the captured image of a receipt. The captured image of a receipt may include a store name receiving a payment (e.g. “convenient store OO”), a logo mark H1 representing the logo image of the store, a date of payment (e.g. “20**year, **month, **day”), items and payments regarding paid goods and categories. Specifically, a payment “¥180” is displayed in the right column of an item of payment “bread”; a payment “¥220” is displayed in the right column of an item of payment “butter”; a payment “¥350” is displayed in the right column of an item of payment “magazine”; and a payment “¥5500” is displayed in the right column of an item of payment “telephone fee”. In this connection, the displayed image of the specific information operation area G11 is part of the captured image of a receipt; actually, other items of payment, amounts of payment, and the total amount of payment are included the receipt blow “telephone fee ¥5500”.

The attribute operation area G12 displays the attribute icons Z1 to Z8 representing attributes which are determined in the personal finance information acquisition application app1 in advance. The attributes of the specific information which can be input by the personal finance information acquisition application app1, are set to the attribute icons Z1 to Z8 in advance. Specifically, the attribute icon Z1 indicates an attribute “logo”, i.e. an operation icon which instructs inputting of a logo of a store after payment. The attribute icon Z2 indicates an attribute “store name”, i.e. an operation icon which instructs inputting of a store name after payment. The attribute icons Z3 to Z6 indicate attributes “foods”, “sundry goods”, “lighting and fuel”, and “communication”, i.e. operation icons which instruct inputting of items of payment and amounts of payment. The attribute icon Z7 indicates an attribute “total”, i.e. an operation icon which instructs inputting of the total amount of payment. The attribute icon Z8 indicates “exit”, i.e. an operation icon which instructs the exit of the personal finance information acquisition application app1. Therefore, the attribute icon Z8 is not used to set a specific attribute but used as an operation icon to indicate processing for each application. The capture data display area G13 is an area to display specific information which is extracted from the captured image of the camera 104 and input to the specific information database 137.

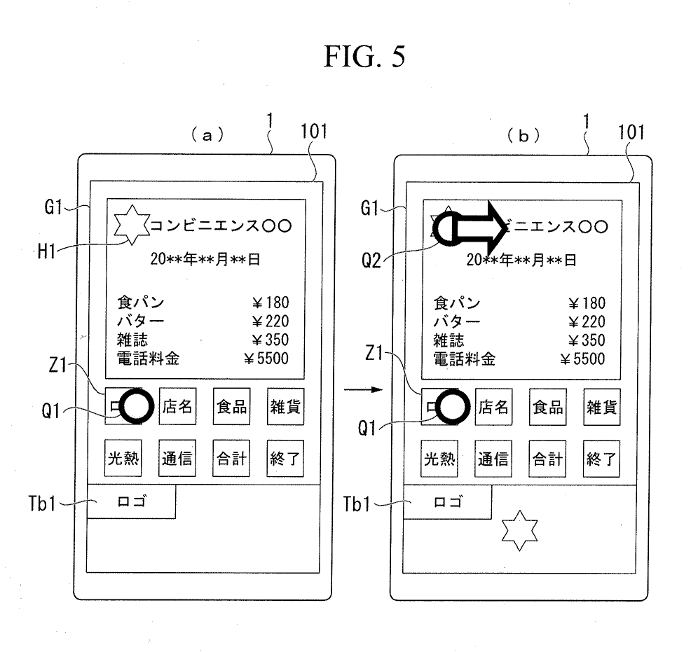

Next, the process and the procedure to input the logo mark H1 of a store after user's payment will be described with reference to FIG. 5. As shown in FIG. 5(a), when a user touches the attribute icon Z1 in the information reception screen G1 displayed on the operation screen of the touch panel 101, the operation content determination part 121 detects a user's touch operation, and therefore the display control part 122 displays a finger icon Q1 superposed on the attribute icon Z1. That is, the finger icon Q1 is displayed at the position of a user's touch operation which is detected on the touch panel 101. This shows the state in which a user maintains a touch operation on the touch panel 101 with a thumb of a user's right hand. Thus, the attribute setting part 1241 of the information acquisition part 124 of the controller 102 sets the attribute “logo” indicated by the attribute icon Z1 as an attribute of specific information based on the determination result of the operation content determination part 121. The attribute setting part 1241 registers attribute information representing the currently set attribute “logo” in the temporary store area 134. The display control part 122 displays a tab Tb1 indicating the currently set attribute “logo” in the upper-left portion of the capture data display area G13.

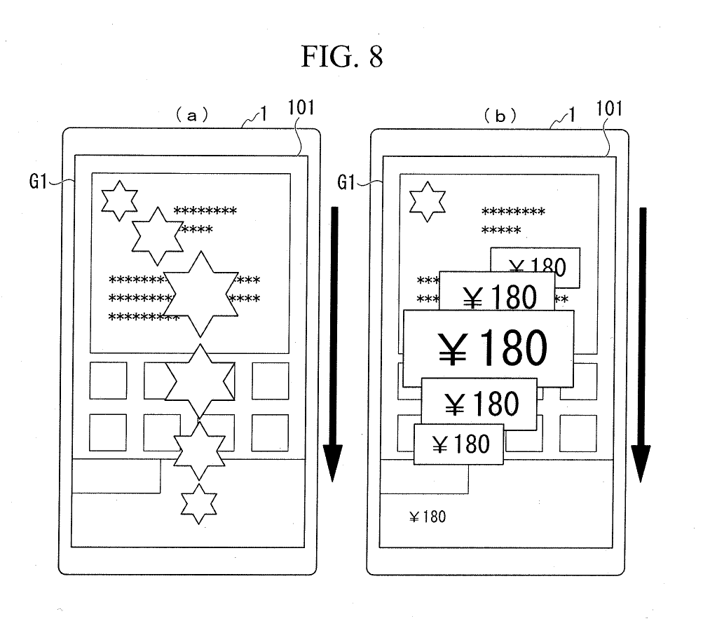

A user may touch the store's logo mark H1 with an index finger (or a middle finger) of a user's right hand so as to carry out a slide operation (i.e. a touch slide operation) while maintaining a touch operation on the attribute icon Z1 with a thumb of a user's right hand. The operation content determination part 121 detects a touch slide operation, and therefore the display control part 122 displays a finger icon Q2 superposed on the store's logo mark H1. As shown in FIG. 5(b), the display control part 122 moves the finger icon Q2 in a moving direction of a user's finger via a touch slide operation. Thus, the specific information acquisition part 1242 of the information acquisition part 124 of the controller 102 acquires specific information representing the store's logo mark H1 corresponding to the display object area which is specified by a user's touch slide operation based on the determination result of the operation content determination part 121. Thereafter, the display control part 124 displays an animation image, representing the movement of the store's logo mark H1 from the specific information operation area G11 to the capture data display area G13, which is superposed on the information reception screen G1. The animation image will be described later with reference to FIG. 8.

When a user retrieves the specific information “logo mark” from the display object area on the condition that the attribute “logo” is set to the capture data display area G13, the information management part 125 writes the attribute “logo” in the specific information database 137 in connection with a file name of the image data of the specific information “logo mark H1”. Thus, it is possible to input the store's logo mark H1, subjected to a user's touch slide operation, as the specific information of the attribute “logo”. The display control part 122 displays an image of the logo mark H1, serving as the specific information which is input by a user, in the capture data display area G13.

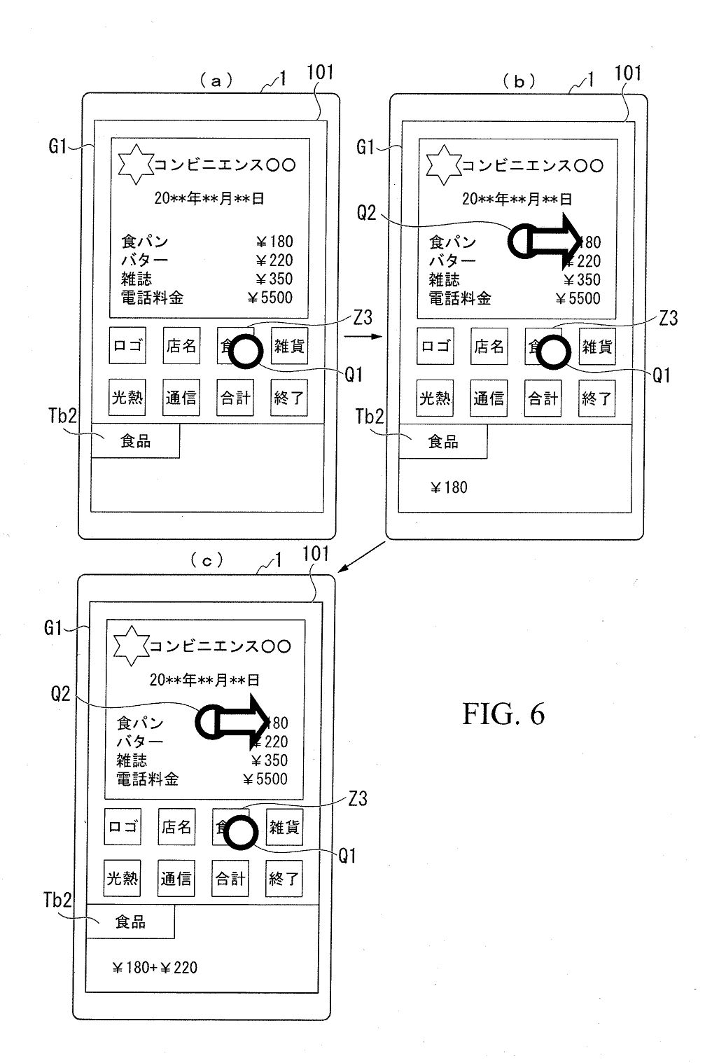

Next, the process and the procedure to input the amount of payment for an item of payment regarding the attribute “foods” from the captured image of a receipt will be described with reference to FIG. 6. As shown in FIG. 6(a), when a user touches the attribute icon Z3 with a user's finger in the information reception screen G1 which is displayed on the operation screen of the touch panel 101, the operation content determination part 121 detects a touch operation, and therefore the display control part 122 displays the finger icon Q1 superposed on the attribute icon Z3. That is, the finger icon Q1 is displayed at the position at which a user's touch operation is detected. Herein, a user touches the attribute icon Z1 with a thumb of a user's right hand while maintaining a touch operation. Thus, the attribute setting part 1241 of the information acquisition part 124 of the controller 102 sets an attribute of specific information representing the attribute “foods” of the attribute icon Z3 based on the determination result of the operation content determination part 121. The attribute setting part 1241 registers the attribute information representing the currently set attribute “foods” in the temporary store area 134. Additionally, the display control part 122 displays a tab Tb2 representing the currently set attribute “foods” in the upper-left portion of the capture data display area G13.

Next, a user carries out a touch slide operation on the payment “¥180” of the item of payment “bread” with an index finger (or a middle finger) of a user's right hand while maintaining a touch operation on the attribute icon Z3 with a thumb of a user's right hand. The operation content determination part 121 detects a user's touch slide operation, and therefore the display control part 122 displays the finger icon Q2 superposed on the payment “¥180” of the item of payment “bread”. As shown in FIG. 6(b), the display control part 122 moves the finger icon Q2 in a moving direction of a user's finger via a touch slide operation. Thus, the specific information acquisition part 1242 of the information acquisition part 124 of the controller 102 acquires specific information representing the payment “¥180” of the item of payment “bread”, which matches the display object area specified via a user's touch slide operation, based on the determination result of the operation content determination part 121. The display control part 124 displays an animation image superposed on the information reception screen G1 when an image of the payment “¥180” of the item of payment “bread” is being moved from specific information operation area G11 to the capture data display area G13. The animation image will be described later with reference to FIG. 8.

When a user retrieves the specific information “¥180” from the display object area on the condition that the attribute “foods” has been set by a user, the information management part 125 writes the specific information “¥180” in connection with the attribute “foods” in the specific information database 137. Thus, it is possible to input the payment “¥180” of the item of payment “bread”, subjected to a user's touch slide operation, as the specific information of the attribute “foods”. Additionally, the information management part 125 sets an additional flag to the attribute “foods” in the specific information database 137. The display control part 122 displays the user's input specific information, representing the payment “¥180” of the item of payment “bread”, in the capture data display area G13.

Next, when a user carries out a touch slide operation on the payment “¥220” of the item of payment “butter” with an index finger (or a middle finger) of a user's right hand while maintaining a touch operation on the attribute icon Z3 with a thumb of a user's right hand, the operation content determination part 121 detects a user's touch slide operation, and therefore the display control part 122 displays the finger icon Q2 superposed on the payment “¥220” of the item of payment “butter”. As shown in FIG. 6(c), the display control part 122 moves the finger icon Q2 in a moving direction of a user's finger via a touch slide operation. Thus, the specific information acquisition part 1242 of the information acquisition part 124 of the controller 102 acquires the specific information representing the payment “¥220” of the item of payment “butter”, which corresponds to the display object area specified via a user's touch slide operation, based on the determination result of the operation content determination part 121. The display control part 124 displays an animation image superposed on the information reception screen G1 when the image of the payment “¥220” of the item of payment “butter” is being moved from the specific information operation area G11 to the capture data display area G13. The animation image will be described later with reference to FIG. 8.

When a user retrieves desired specific information from the display object area on the condition that a desired attribute has been already set by a user, the information management part 125 writes the specific information in connection with the attribute in the specific information database 137. As the specific information of the attribute “foods”, the payment “¥180” of the item of payment “bread” has been already written in the specific information database 137. Therefore, an additional flag is set to the attribute “foods” in the specific information database 137. Additionally, the attribute information of the currently set attribute “foods” has been already registered in the temporary store area 134.

To write the payment “¥220” of the item of payment “butter” in the specific information database 137 on the condition that an additional flag was already set to the attribute “foods”, the information management part 125 additionally writes an addition symbol “+” subsequent to the specific information “¥180”, which is written in correspondence with the attribute “foods”, and then writes the payment “¥220” of the item of payment “butter”. That is, the information management part 125 writes “¥180+¥220” as the specific information in connection with the attribute “foods” in the specific information database 137. Thus, it is possible to input the payment “¥220” of the item of payment “butter”, subjected to a user's touch slide operation, as the specific information of the attribute “foods”. The information management part 125 determines as to whether or not the attribute information, representing the currently set attribute, in the temporary store area 134. Upon determining that the attribute information is registered in the temporary store area 134, the information management part 125 may additionally write an addition symbol “+” subsequent to the specific information “¥180”, which is written in connection with the attribute “foods”, and then write the payment “¥220” of the item of payment “butter”. The display control part 122 an image of “¥180+¥220”, representing that the payment “¥220” of the item of payment “butter, representing the user's input specific information, is added to the payment “¥180”, in the capture data display area G13.

To add specific information in the specific information database 137, the information management part 125 additionally writes an addition symbol “+” and then writes new specific information subsequent to the specific information which was already written. Another example of processing in this case will be described below. To add specific information in the specific information database 137, the information management part 125 may calculate the total amount of payment “¥440”, in which the payment “¥220” of the item of payment “butter” is added to the payment “¥180” of the item of payment “bread” which was already written, and then overwrite the foregoing specific information correlated to the attribute “foods” with the total amount of payment “¥400”. In this case, the display control part 122 displays the total amount of payment “¥400”, in which the payment “¥220” of the item of payment “butter” is added to the payment “¥180” of the item of payment “bread” representing the user's input specific information, in the capture data display area G13.

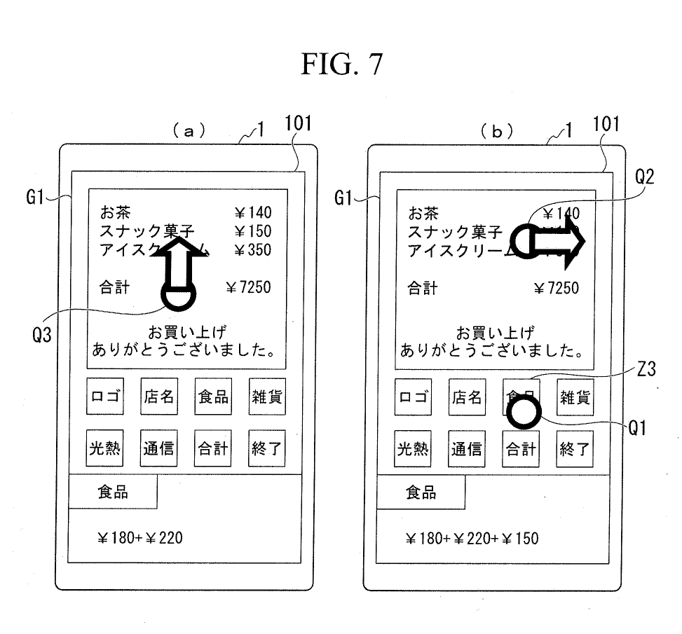

Next, the process and the procedure subsequent to the procedure shown in FIG. 6 will be described with reference to FIG. 7. After a user releases a touch operation on the attribute icon Z3 in the state of FIG. 6(c), a user may touch one point in the specific information operation area G11 so as to carry out a flick operation in an upward direction with a user's finger. In this case, the operation content determination part 121 detects a user's flick operation, and therefore the display control part 122 displays a finger icon Q3 superposed on the touch position of a user's finger in the specific information operation area G11. Thus, as shown in FIG. 7(a), the captured image of a receipt in the specific information operation area G11 is scrolled in an upward direction, and therefore an image representing the lower part of a receipt is continuously displayed.

Next, a user carries out a touch operation on the attribute icon Z3 with a thumb of a user's right hand. The operation content determination part 121 detects a user's touch operation, and therefore the display control part 122 displays the finger icon Q1 superposed on the attribute icon Z3. Additionally, the information management part 125 sets an additional flag to the attribute “foods” in the specific information database 137. The attribute information representing the attribute “logo” which is currently set by a user is stored in the temporary store area 134. In this case, the attribute setting part 1241 does not rewrite the stored contents of the specific information database 137 and the temporary store area 134 since a user does not change the attribute specified via a touch operation. In contrast, the attribute information setting part 1241 rewrites the stored contents of the specific information database 137 and the temporary store area 134 due to a change of the attribute information.

When a user carries out a touch slide operation on the payment “¥150” of the item of payment “snack” with an index finger (or a middle finger) of a user's right hand while maintaining a touch operation on the attribute icon Z3 with a thumb of a user's right hand, the operation content determination part 121 detects a user's touch slide operation, and therefore the display control part 122 displays the finger icon Q2 superposed on the payment “¥150” of the item of payment “snack”. As shown in FIG. 7(b), the display control part 122 moves the finger icon Q2 in a moving direction of a user's finger via a touch slide operation. Thus, the specific information acquisition part 1242 of the information acquisition part 124 of the controller 102 acquires the specific information, representing the payment “¥150” of the item of payment “snack” which corresponds to the display object area specified via a user's touch slide operation, based on the determination result of the operation content determination part 121. The display control part 122 displays an animation image superposed on the information reception screen G1 when an image of the payment “¥150” of the item of payment “snack” is being moved from the specific information operation area G11 to the capture data display area G13. The animation image will be described later with reference to FIG. 8.

When a user retrieves the specific information “¥150” from the display object area on the condition that the attribute “foods” is set by a user, the information management part 125 writes the specific information “¥150” in connection with the attribute “foods” in the specific information database 137. As the specific information of the attribute “foods”, the payment “¥180” of the item of payment “bread” and the payment “¥220” of the item of payment “butter” has been already written in the specific information database 137. Therefore, an additional flag is set to the attribute “foods” in the specific information database 137. Additionally, the attribute information representing the currently set attribute “foods” is registered in the temporary store area 134.

To write the payment “¥150” of the item of payment “snack” in the specific information database 137 on the condition that an additional flag is set to the attribute “foods”, the information management part 125 additionally writes an addition symbol “+” subsequent to “¥180-¥220”, which was written in connection with the attribute “foods”, and then writes the payment “¥150” of the item of payment “snack”. That is, the information management part 125 writes “¥180-¥220-¥150” in the specific information database 137 as the specific information correlated to the attribute “foods”. Thus, the payment “¥150” of the item of payment “snack”, subjected to a user's touch slide operation, is input as the specific information of the attribute “foods”. The information management part 125 determines as to whether or not the currently set attribute information is stored in the temporary store area 134. Upon determining that the attribute information is stored in the temporary store area 134, the information management part 125 may additionally write an addition symbol “+” subsequent to the specific information “¥180+¥220”, which was written in connection with the attribute “foods”, and then write the payment “¥150” of the item of payment “snack”. The display control part 122 displays the total amount of payment “¥180-¥220-¥150”, in which the payment “¥150” of the item of payment “snack” which is newly input by a user is added to the total amount of payment “¥180-¥220” between the items of payment “bread” and “butter”, in the capture data display area G13.

Next, an animation image, which is displayed in the information reception screen G1 when a user specifies a display object to input specific information in the specific information operation area G11, will be described with reference to FIG. 8. FIG. 8(a) shows an animation image which is displayed when the logo mark H displayed in the specific information operation area G11 is input as specific information. An animation image is displayed as shown in FIG. 8(a) such that an image of the specific information “logo mark H1” is gradually enlarged while the image of the specific information “logo mark H1” is being moved from the specific information operation area G11 to the capture data display area G13; thereafter, the image will be gradually reduced in size after the image reaches the maximum size. In the animation image shown in FIG. 8(a), a plurality of images representing “logo mark H1” is continuously displayed in a time-series manner in the information reception screen G1.

FIG. 8(b) shows an animation image which is displayed when the payment “¥180” of the item of payment “bread” displayed in the specific information operation area G11 is input as specific information. An animation image is displayed as shown in FIG. 8(b) such that the image of the specific information “¥180” is gradually enlarged while the image of the specific information “¥180” is being moved from the specific information operation area G11 to the capture data display area G13; thereafter, the image will be gradually reduced in size when the image reaches the maximum size. In the animation image shown in FIG. 8(b), a plurality of images representing “¥180” is continuously displayed in a time-series manner in the specific information reception part G1.

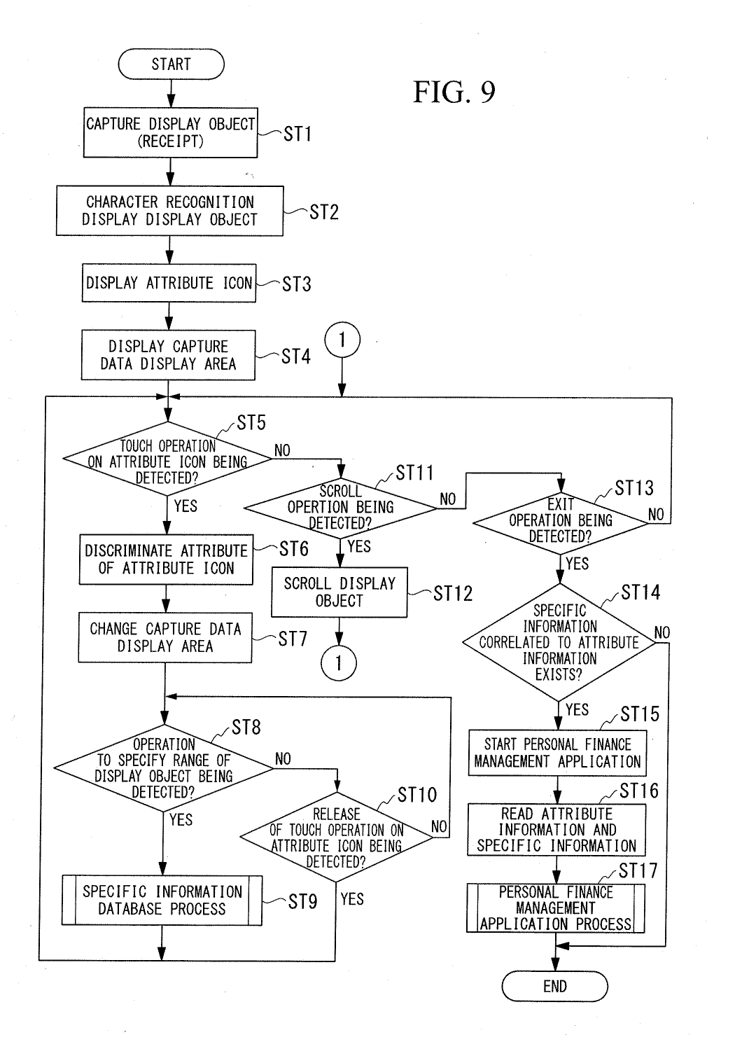

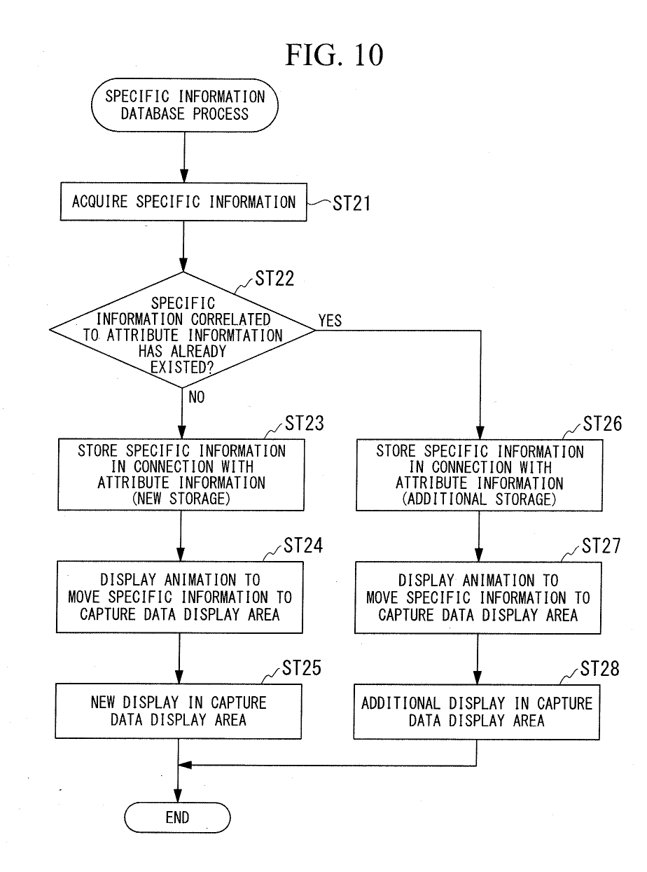

Next, the processing of the portable terminal 1 will be described with reference to FIGS. 9 and 10. FIG. 9 is a flowchart showing the basic process of the portable terminal 1.

### (Step ST1)

First, a user operates the operation part 111 of the touch panel 10 so as to start the personal finance information acquisition application app1. The application processing part 126 of the controller 102 reads and executes the personal finance information acquisition application app1 from the application store area 135 of the store part 103. Thus, an image-capturing mode is started. Next, the camera control part 105 starts the camera 104 in an image-capturing mode. The camera 104 captures a display object as a captured object in accordance with a user's image-capturing instruction applied to the touch panel 101. Herein, the display object indicates the information described in a receipt. The camera 104 generates image data which is then subjected to image processing via the image processing part 106, and therefore the image processing result is stored in the camera image store area 131.

### (Step ST2)

The controller 102 starts a database mode in accordance with the personal finance information acquisition application app1. The display control part 122 displays the information reception screen G1 on the display 112 of the touch panel 101 in a database mode. For example, the display control part 122 displays the information reception screen G1 shown in FIG. 4 on the display 112. That is, the display control part 122 displays the captured image of a receipt in the specific information operation area G11 within the information reception screen G1. Herein, the image of a receipt which is displayed on the display 112 of the touch panel 101 is tied with text data and schematic data which are extracted from the image data of a receipt via the image analysis part 107.

### (Step ST3)

The display control part 122 displays the attribute icons Z1 to Z8 in the attribute operation area G12 within the information reception screen G1.

### (Step ST4)

The display control part 122 displays a blank display area in the capture data display area G13 within the information reception screen G1. First, a tab representing an attribute is not displayed in the capture data display area G13. This is because a user does not specify any attributes at this time.

### (Step ST5)

As shown in FIG. 4, the information reception screen G1 is displayed on the operation screen of the touch panel 101. The operation content determination part 121 determines as to whether or not a user carries out a touch operation to specify any one of the attribute icons Z1 to Z8 based on the detection result of the operation part 111 of the touch panel 101. When the operation content determination part 121 detects a user's touch operation, the display control part 122 displays the finger icon Q1 superposed on the information reception screen G1.

### (Step ST6)

Upon determining that a user carries out a touch operation on the attribute operation area G12 based on the detection result of the operation part 111 of the touch panel 101, the operation determination part 121 determines as to which attribute icon among the attribute icons Z1 to Z8 is specified by a user. The operation content determination part 121 determines to set an attribute representing an attribute icon which is specified by a user. For example, the operation content determination part 121 determines to set the attribute “logo” when a user touches the attribute icon Z2 with a user's finger. The attribute setting part 1241 of the information acquisition part 124 determines the currently set attribute representing the attribute “logo” of the attribute icon Z1 which is specified by a user. The attribute setting part 1241 sets an additional flag to the attribute information representing the currently set attribute “logo”. Alternatively, the attribute setting part 1241 registers the attribute information, representing the currently set attribute “logo”, in the temporary store area 134.

### (Step ST7)

The display control part 124 displays a tag representing the currently set attribute in the upper-left portion of the capture data display area G13. In FIG. 5, the tab Tb1 representing the currently set attribute “logo” is displayed in the capture data display area G13.

### (Step ST8)

The operation content determination part 121 determines as to whether or not a user carries out a touch slide operation to specify a display object area in the specific information operation area G11 based on the detection result of the operation part 111 of the touch panel 101. When the operation content determination part 121 detects a touch slide operation, the display control part 122 displays the finger icon Q2 at the touch position of a user's finger while superposing it on the specific information operation area G11 of the information reception screen G1.

### (Step ST9)

The specific information acquisition part 1242 of the information acquisition part 124 executes a specific information database process to acquire the specific information, which a user specifies within the image of a receipt, in response to a display object area which is specified via a user's touch slide operation. The details of the specific information database process will be described with reference to FIG. 10.

### (Step ST10)

When a user does not carry out a touch slide operation on the specific information operation area G11, the operation content determination part 121 determines as to whether or not a user separates a thumb of a user's right hand from the attribute icon Z1 so as to release a touch operation. Until a user releases a touch operation, the operation content determination part 121 repeats a decision as to whether or not a user carries out a touch slide operation on the specific information operation area G11. When a user releases a touch operation, the flow returns to step ST5.

### (Step ST11)

In step ST5, when a user's touch operation to specify any one of the attribute icons Z1 to Z8 is not detected, the operation content determination part 121 determines as to whether or not a user's scroll operation is detected.

### (Step ST12)

When the operation content determination part 121 detects a user's scroll operation, as shown in FIG. 7(a), the display control part 122 scrolls the displayed content of the information reception screen G1 in a scrolling direction on the display 112 of the touch panel 101.

### (Step ST13)

When a user's scroll operation is not detected, the operation content determination part 121 determines whether or not to exit the personal finance information acquisition application app1 based on the detection result of the operation part 111 of the touch panel 101.

### (Step ST14)

When a user operates the operation part 111 to exit the personal finance information acquisition application app1, the flow proceeds to step ST14. For example, when a user carries out a touch operation on the attribute icon Z8 in the attribute operation are G11, the operation content determination part 121 determines to exit the personal finance information acquisition application app1. Thereafter, the application processing part 126 determines as to whether or not the attribute information and the specific information are stored in connection with each other with reference to the specific information store area 136 of the store part 103.

### (Step ST15)

When the attribute information and the specific information are stored in the specific information store area 136 in connection with each other, the application processing part 126 starts the program of the personal finance management application app2.

### (Step ST16)

The application processing part 126 reads the attribute information and the specific information, which are mutually connected to each other, from the specific information store area 1136 in accordance with the personal finance management application app2.

### (Step ST17)

The application processing part 126 executes the program of the personal finance management application app2 based on the attribute information and the specific information which are read from the specific information store area 136. The application processing part 126 additionally writes the specific information in connection with the attribute information in personal finance data. The application processing part 126 may update personal finance data, which is managed for each date of updating, based on the date clocked by the clock 110. When the image of a receipt is included in the date information, the image analysis part 107 may extract the date information from the image of a receipt so as to write it in the temporary store area 134 in connection with the image data of a receipt. To update personal finance data for each attribute based on the specific information which is read from the specific information database 137, the information management part 125 may read the date information, which is connected to the image data of receipt, from the temporary store area 134, thus updating personal finance data for each date indicated by the date information.

Next, the specific information database process of the portable terminal 1 will be described with reference to FIG. 10. FIG. 10 shows the process implementing the procedure shown in FIG. 6.

### (Step ST21)

When the operation content determination part 121 determines that a user's touch slide operation is carried out on a display object area in the specific information operation area G11, the specific information acquisition part 1242 detects the display object area which is specified by a user. Upon detecting the display object area which is specified via a user's touch slide operation, the specific information acquisition part 1242 acquires a display object (i.e. text data and schematic data) included in the display object area. For example, when the character portion displayed in the specific information operation area G11 is tied with text data which is extracted by the information analysis part 107, the specific information acquisition part 1242 acquires specific information representing text data which is tied with the display object area specified via a user's touch slide operation. As shown in FIG. 6(b), when a user carries out a slide touch operation to specify the display object area including the payment “¥180” of the item of payment “bread”, which is displayed in the specific information operation area G11, while maintaining a touch operation on the attribute icon Z3 with a thumb of a user's right hand, the specific information acquisition part 1242 acquires text data “¥180” which is tied with the display object area including the payment “¥180” of the item of payment “bread” specified by a user.

### (Step ST22)

The information management part 125 determines as to whether or not an additional flag is set to the currently set attribute “foods” with reference to the specific information database 137 of the specific information store area 136. That is, the information management part 125 determines as to whether or not the specific information connected to the currently set attribute is stored in the specific information database 137. Additionally, the information management part 125 determines as to whether or not the attribute information representing the currently set attribute is stored in the temporary store area 134.

### (Step ST23)

When an additional flag is not set to the attribute “foods” in the specific information database 137 of the specific information store area 136, the information management part 125 determines that the specific information connected to the currently set attribute “foods” is not stored in the specific information database 137. Thereafter, the information management part 125 sets an additional flag to the attribute “foods” and then writes the specific information “¥180” in the specific information database 137 in connection with the attribute information. Additionally, when the attribute information representing the currently set attribute is not stored in the temporary store area 134, the information management part 125 determines that the specific information connected to the currently set attribute “foods” is not stored in the specific information database 137. Thereafter, the information management part 125 stores the attribute information representing the currently set attribute “foods” in the temporary store area 134 and then writes the specific information “¥180” in the specific information database 137 in connection with the attribute information.

### (Step ST24)

The display control part 124 displays an animation image superposed on the information reception screen G1 when the specific information “¥180” is being moved to the capture data display area G13. In the animation image shown in FIG. 8(b), the image of the specific information “¥180” is being moved in a time-series manner from the specific information operation area G11 to the capture data display area G13. That is, the image of the specific information “¥180” is display such that the image is gradually enlarged while the image is being moved from the specific information operation area G11 to the capture data display area G13; thereafter, the image will be gradually reduced in size.

### (Step ST25)

After displaying the aforementioned animation image (i.e. after the image of the specific information “¥180” is moved to the capture data display area G13), the display control part 124 writes the specific information “¥180” in the capture data display area G13. As shown in FIG. 6(b), the specific information “¥180” is displayed in the capture data display area G13.

### (Step ST26)

When an additional flag is set to the attribute “foods” in the specific information database 137 of the specific information store area 136, the information management part 125 writes the user's input specific information in the specific information database 137. In step ST21, the information shown in FIG. 6(c) is displayed on the touch panel 101 of the portable terminal 1 while the finger icons Q1, Q2 are displayed via user's operations. Herein, a user carries out a touch operation on the attribute icon Z3 representing the attribute “foods” while a user carries out a touch slide operation on a desired display object area (i.e. an area encompassing the payment “¥220” of the item of payment “butter”) in the specific information operation area G11. In this case, the specific information acquisition part 1242 acquires text data “¥220” tied with the desired display object area. The information management part 125 writes additional specific information indicating that the newly acquired specific information “¥220” is added to the specific information “¥180” which was already written in connection with the currently set attribute “foods”. That is, the additional specific information “¥180+¥220” is written in connection with the attribute “foods” in the specific information database 137.

### (Step ST27)

The display control part 122 displays an animation image superposed on the information reception screen G1 when the newly acquired specific information “¥220” is being moved from the specific information operation area G11 to the capture data display area G13. In the animation image shown in FIG. 8(b), the image of the specific information “¥220” is gradually enlarged; thereafter the image will be gradually reduced in size.

### (Step ST28)

After displaying the aforementioned animation image, the display control part 122 displays the additional specific information, indicating that the newly moved specific information “¥220” is added to the already moved specific information “¥180”, in the capture data display area G13. Thus, as shown in FIG. 6(c), the additional specific information “¥180+¥220” is displayed in the capture data display area G13.

The information reception screen G1 including the specific information operation area G11, the attribute operation area G12, and the capture data display area G13 is displayed on the operation screen which is used to input display objects (i.e. specific information). Thus, it is possible to improve the usability for a user to input a display object (specific information) which is specified for each attribute. To specify a display object which a user needs to input as update information for personal finance data, a user selectively touches one of the attribute icons Z1 to Z8, which are displayed in the attribute operation area G12, so as to select an attribute which is a subject to input specific information. To add specific information in connection with attribute information, a user may carry out a touch slide operation on a desired display object (specific information) while touching a desired attribute icon, thus inputting desired specific information. Thus, it is possible for a user to easily update specific information with a simple operation to specify a display object which needs to be updated for each attribute which is a subject to update personal finance data.

The information management part 125 prepares the specific information database 137 which stores the user's input display object (specific information) in connection with attribute information. Thus, the application processing part 126 is able to update personal finance data for each attribute. Additionally, the application processing part 126 displays the attribute icons Z1 to Z7, indicating the attributes subjected to updating, in the information reception screen G1 in accordance with the personal finance management application app2. That is, the item of the specific information of the specific information database 137 which is prepared by the application processing part 126 matches the item of the attribute which is a subject to update personal finance data with the application processing part 126. Thus, it is possible to use the specific information (i.e. text data and schematic data) acquired by the information acquisition part 124 in the process of the personal finance management application app2.

### Second Embodiment

Next, a portable terminal 1A according the second embodiment will be described. The portable terminal 1A of the second embodiment has the same configuration (see FIG. 2) as the portable terminal 1 of the first embodiment. In the following description, a text editing application app3 is stored in the application store area 135 of the store part 103. Text data which is subjected to the processing of the text editing application app3 is stored in the display object store area 132 of the store part 103.

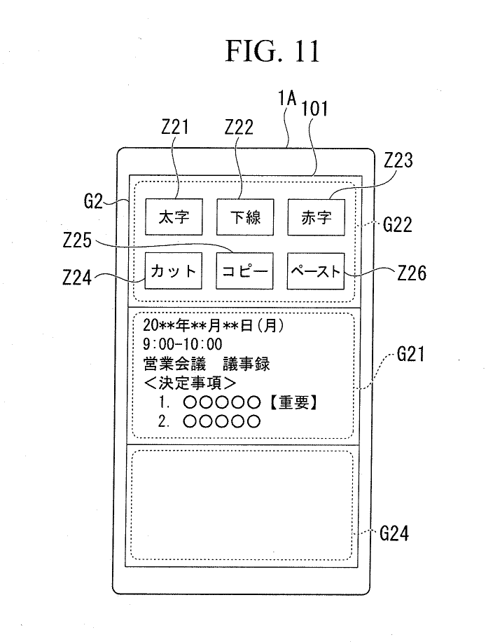

FIG. 11 shows an information reception screen G2 which is displayed on the touch panel 101 when starting the text editing application app3. The information reception screen G2 which is executed by the program of the text editing application app3 is displayed on the operation screen of the touch panel 101 when the controller 102 reads text data, which is subjected to a text editing process, from the display object store area 132 of the store part 103. As shown in FIG. 11, the information reception screen G2 includes a specific information operation area G21 which is used to display text data subjected to a text editing process, an attribute operation area G22 which is used to display attributes Z21 to Z26 specifying attributes, and a work display area G24 which is used to display text which is input by a user who operates the operation part 111. The attribute operation area G22 is displayed at the upper portion of the operation screen while the work display area G24 is displayed in the lower part of the operation screen. The specific information operation area G21 is displayed at the intermediate position between the attribute operation area G22 and the work display area G24.

Text data subjected to a text editing process is displayed in the specific information operation area G21. Herein, year/month/date “20**year**month**day (Mon)”, time “9:00-10:00”, titles “business meeting, minutes”, and agendas “<decision matters>1. OOOOO [important] 2. OOOOO” are displayed in the text data. In this connection, images displayed in the specific information operation area G21 form part of the text data.

The attribute icons Z21 to Z26 which are determined in the text editing application app3 in advance are displayed in the attribute operation area G22. As the attributes of the attribute icons Z21 to Z26, various types of text editing processes which can be executed via the text editing application app3 are determined in advance. As the types of text editing processes executable via the text editing application app3, for example, it is possible to determine text data formats, shapes of characters, fonts, colors of characters, sizes of characters, and rotation angles. Specifically, the attribute icon Z21 indicates the attribute “boldface”, i.e. an operation icon to modify characters of specific information in bold faces. The attribute icon Z22 indicates the attribute “underline”, i.e. an operation icon to add an underline to specific information. The attribute icon Z23 indicates the attribute “red”, i.e. an operation icon to modify the color of characters of specific information in red. The attribute icon Z24 indicates the attribute “cut”, i.e. an operation icon to execute cut editing to cut out specific information. The attribute icon Z25 indicates the attribute “copy”, i.e. an operation icon to execute copy editing to temporarily save specific information. The attribute icon Z26 indicates the attribute “paste”, i.e. an operation icon to execute paste editing to paste specific information which is temporarily saved via copy editing.

The work display area G24 receives the user's input characters with respect to text data which is displayed in the specific information operation area G21. For example, a key input means such as a QWERTY keyboard and a ten-key unit is displayed in the work display area G24 so as to receive characters and numbers which are input via user's touch operations on keys. The work display area G24 may receive user's handwriting.

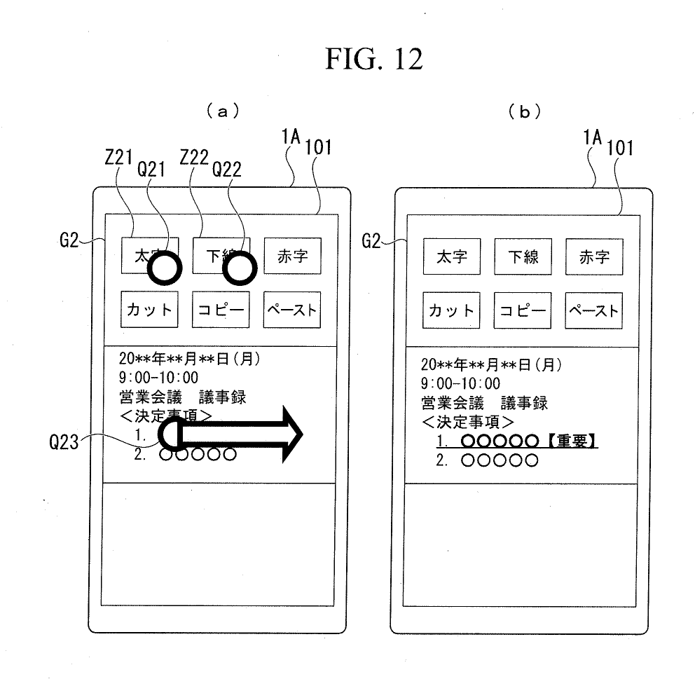

Next, the user's operation and the procedure in text editing on text data will be described with reference to FIG. 12. As shown in FIG. 12(a), the information reception screen G2 is displayed on the operation screen of the touch panel 101, wherein, when a user touches the attribute icons Z21 and Z22 with user's fingers, the operation content determination part 121 detects user's touch operations, and therefore the display control part 122 displays a finger icon Q21 superposed on the attribute icon Z21 and a finger icon Q22 superposed on the attribute icon Z22. The finger icons Q21 and Q22 are displayed at the positions of detecting user's touch operations. Specifically, a user touches the attribute icon Z21 with an index finger of a user's right hand while maintaining a touch operation. At the same time, a user touches the attribute icon Z22 with a middle finger of a user's right hand while maintaining a touch operation. Based on the determination result of the operation content determination part 121, the attribute setting part 241 of the information acquisition part 124 of the controller 102 sets the attribute “boldface” indicated by the attribute icon Z21 and the attribute “underline” indicated by the attribute icon Z22 as the attributes of the specific information which are acquired by a user. The attribute setting part 1241 registers the attribute information, representing the currently set attributes “boldface” and “underline”, in the temporary store area 134.

When a user carries out a touch slide operation on a portion “1. OOOOO [important]” of the text data displayed in the specific information operation area G21 with a thumb of a user's right hand while maintaining touch operations on the attribute icons Z21 and Z22, the operation content determination part 121 detects a user's touch slide operation, and therefore the display control part 122 displays a finger icon Q23 superposed on a portion “1. OOOOO [important]” of the text data. As shown in FIG. 12(a), the display control part 122 moves the finger icon Q23 in a moving direction of a user's finger via a user's touch slide operation. Thus, the specific information acquisition part 1242 of the information acquisition part 124 of the controller 102 acquires the specific information, i.e. a portion “1. OOOOO [important]” of the text data in the display object area which is specified via a user's touch slide operation, based on the determination result of the operation content determination part 121. The application processing part 126 executes text editing to modify character fonts in bold faces with respect to a portion “1. OOOOO [important]” of the text data while drawing underlines below character strings. The display control part 124 displays a portion “1. OOOOO [important]” after text editing (i.e. character strings subjected to boldface/underline processing as shown in FIG. 12(b)).

Thus, when the attributes “boldface” and “underline” are set via user's operations while the specific information of “1. OOOOO [important]” is retrieved from the display object area, the information management part 125 outputs the attributes “boldface” and “underline” to the application processing part 126 in connection with the specific information of “1. OOOOO [important]”. The application processing part 126 edits the specific information of “1. OOOOO [important]” according to the types of text editing representing the attributes “boldface” and “underline”, thus outputting the edited specific information to the display control part 122. The display control part 122 replaces the specific information of “1. OOOOO [important]” displayed in the specific information operation area G12 with the specific information of “1. OOOOO [important]” which is processed by the application processing part 126 (i.e. character strings modified with boldface/underline as shown in FIG. 12(b)).

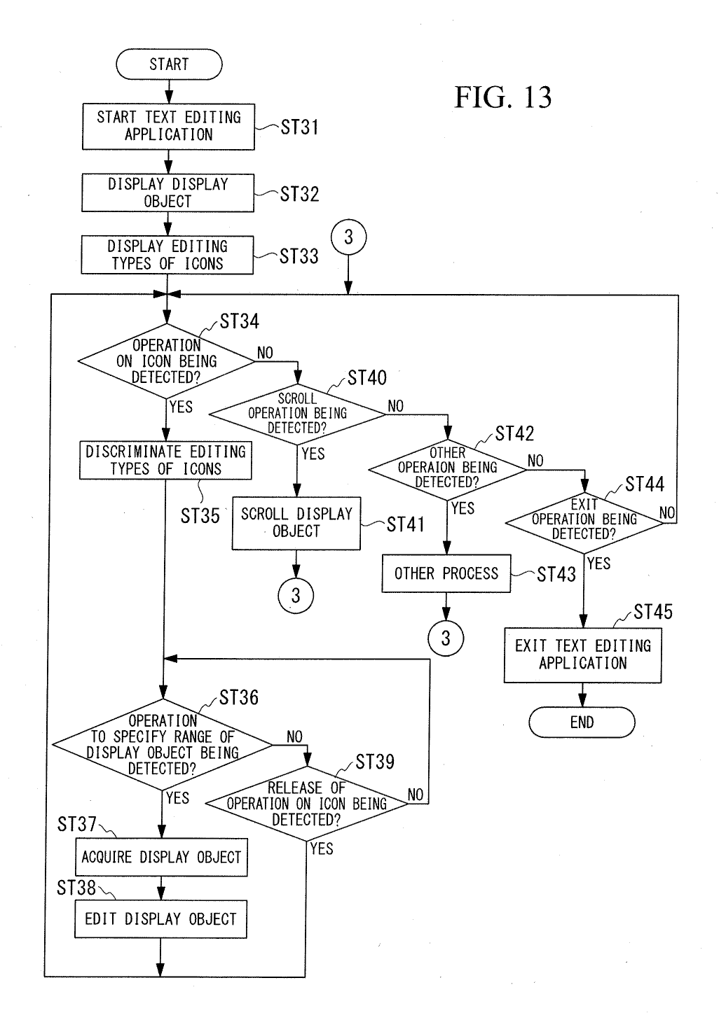

Next, the basic process of the portable terminal 1A according to the second embodiment of the present invention will be described with reference to FIG. 13.

### (Step ST31)

First, a user operates the operation part 111 of the touch panel 101 so as to start the text editing application app3. The application processing part 126 of the controller 102 reads and executes the program of the text editing application from the application store area 135 of the store part 103.

### (Step ST32)

The application processing part 126 reads text data subjected to editing from the display object store area 132 of the store part 103 so as to display the information reception screen G2 in the display 112 of the touch panel 101 in accordance with the text editing application app3. Herein, the display control part 122 displays the information reception screen G2 shown in FIG. 12 on the display 112. Additionally, the display control part 122 displays the read text data in the specific information operation area G21 within the information reception screen G2. In this connection, a user has selected the text data subjected to editing among a plurality of text data stored in the display object store area 132.

### (Step ST33)

The display control part 122 displays the attribute icons Z21 to Z26 belonging to the attribute operation area G22 in the information reception screen G2. Additionally, the display control part 122 displays the predetermined work display area G24 in the information reception screen G2.

### (Step ST34)

Thus, the information reception screen G2 shown in FIG. 12 is displayed on the operation screen of the touch panel 101. The operation content determination part 121 determines as to whether or not a user touches any one of the attribute icons Z21 to Z26 based on the detection result of the operation part 111 of the touch panel 101. When the operation content determination part 121 detects a user's touch operation, the display control part 122 displays the finger icons Q1 and Q2 which are superposed on the information reception screen G2.

### (Step ST35)

Upon determining that a user's touch operation is applied to the attribute operation area G22 based on the detection result of the operation part 111 of the touch panel 101, the operation content determination part 121 determines as to which attribute icon among the attribute icons Z21 to Z26 is specified by a user based on the touch position of a user's finger. Thereafter, the operation content determination part 121 determines that a user sets the attribute corresponding to the user's specified attribute icon. For example, when a user touches the attribute icon Z21 with a user's finger, the operation content determination part 121 determines that a user intends to set the attribute “boldface”. When a user touches the attribute icon Z22 with a user's finger, the operation content determination part 121 determines that a user sets the attribute “underline” with a user's finger. The attribute setting part 1241 of the information acquisition part 124 sets the attributes “boldface” and “underline”, which are indicated by a user, as the currently set attributes. That is, the attribute setting part 1241 stores the attribute information, representing the currently set attributes “boldface” and “underline”, in the temporary store area 134.

### (Step ST36)

The operation content determination part 121 determines as to whether or not a user's touch slide operation is carried out to specify a display object area displayed in the specific information operation area G21 based on the detection result of the operation part 111 of the touch panel 101. When the operation content determination part 121 detects a user's touch slide operation, the display control part 122 displays the finger icon Q23, which is superposed on the specific information operation area G21 of the information reception screen G2, at the touch position of a user's finger.

### (Step ST37)

The specific information acquisition part 1242 of the information acquisition part 124 acquires a display object which is specified by a user. That is, the specific information acquisition part 1242 acquires the specific information “1.OOOOO [important]”, which is selected from among text data, in the display object area which is specified via a user's touch slide operation.

### (Step ST38)

The application processing part 126 executes the type of text editing, which is indicated by the user's set attribute, with respect to the user's specified display object (specific information). That is, the application processing part 126 executes text editing to modify character fonts in bold faces and to draw underlines below character strings with respect to a portion “1.OOOOO [important]” of text data. The display control part 124 changes a portion “1.OOOOO [important]” of text data with “1.OOOOO [important]” after text editing (i.e. character strings modified with boldface/underline as shown in FIG. 12(b)).

### (Step ST39)

When a user does not carry out a touch slide operation on the specific information operation area G21, the operation content determination part 121 determines as to whether or not a user separates user's fingers from the attribute icons Z21 and Z22 so as to release touch operations. Until a user releases touch operations, the operation content determination part 121 repeats a decision as to whether or not a user carries out a touch slide operation. The flow returns to step ST34 when a user releases touch operations.

### (Step ST40)

In step ST34, the operation content determination part 121 determines as to whether or not to a user's scroll operation is detected on the condition that a user's touch operation specifying any one of the attribute icons Z21 to Z26 is not detected.

### (Step ST41)

When the operation content determination part 121 detects a user's scroll operation, the display control part 122 scrolls the picture of the information reception screen G2 which is displayed on the display 112 of the touch panel 101. Thus, it is possible to change the text data of the specific information operation area G21 shown in FIGS. 11 and 12 or to display the picture outside the area of the specific information operation area G21.

### (Step ST42)

Based on the detection result of the operation part 111 of the touch panel 101, the operation determination part 121 determines as to whether or not a user carries out other operations on the condition that a user's scroll operation is not detected. For example, the operation content determination part 121 determines as to whether or not a user inputs character information in the work display area G24 so as to write it into the specific information operation area G21 at the user's specified position.

### (Step ST43)

The controller 102 executes processes suited to user's operations when a user carries out other operations in step ST42. For example, when a user carries out a key-input operation in the work display area G24 so as to input a desired character string, the controller 102 writes the input character string in the specific information operation area G21 at the user's specified position.

### (Step ST44)

Based on the detection result of the operation part 111 of the touch panel 101, the operation content determination part 121 determines whether or not to exit the text editing application app3 on the condition that other user's operations are not detected in step ST42.

### (Step ST45)

When a user operates the operation part 111 of the touch panel 101 so as to exit the text editing application app3, the controller 102 exits the application program.

As described above, the portable terminal 1A of the second embodiment is able to execute processing suited to the type of text editing, indicated by the attributes “boldface” and “underline”, with respect to the specific information “1.OOOOO [important]” on the condition that a user sets the attributes “boldface” and “underline” while retrieving the specific information “1.OOOOO [important]” from the display object area. That is, the present embodiment is able to execute the type of processing suited to attributes with respect to subjects of editing (display objects) which are retrieved as specific information. Thus, a user may execute the type of processing suited to attributes by specifying attribute icons and display objects which are displayed on the operation screen. Therefore, it is possible to improve the usability, and it is possible for a user to intuitively operate the portable terminal 1A so as to execute the processing suited to attributes on desired specific information.

### Third Embodiment

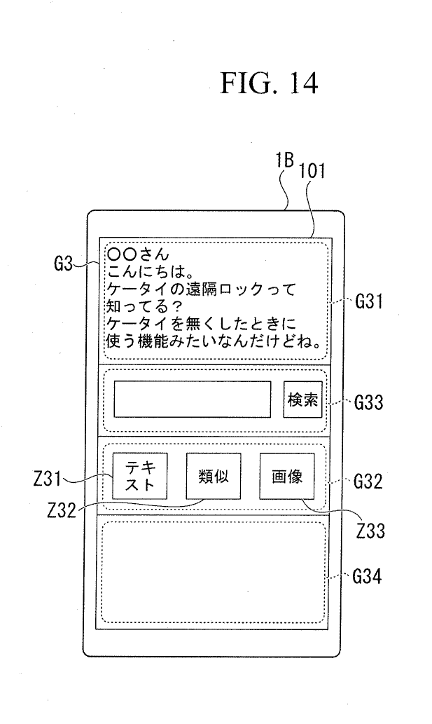

Next, a portable terminal 1B according to the third embodiment of the present invention will be described. The portable terminal 1B of the third embodiment has the same configuration as the portable terminal 1 of the first embodiment (see FIG. 2). In the present embodiment, a search application app4 is stored in the application store area 135 of the store part 103. Additionally, text data, i.e. a subject which is searched via the search application app4, is stored in the display object store area 132 of the store area 103. FIG. 14 shows an information reception screen G3 which is displayed on the touch panel 101 when the portable terminal 1B starts the search application app4. The information reception screen G3 is displayed on the operation screen of the touch panel 101 when the controller 102 executes the program of the search application app4 so as to read text data subjected to searching from the display object store area 132 of the store part 103.

As shown in FIG. 14, the information reception screen G3 includes a specific information operation area G31 which is used to display text data subjected to searching, an attribute operation area G32 which is used to display attribute icons Z31 to Z33 specifying the predetermined attributes, an input operation area G33 which is used to display specific information specified by a user in the specific information operation area G31, and a search result display area G34 which is used to display the search result of a search operation based on the specific information which is input to the input operation area G33 via execution of the program of the search application app4. The specific information operation area G31 is displayed in the upper portion of the operation screen while the search result display area G34 is displayed in the lower portion of the operation screen. Additionally, the input operation area G33 and the attribute operation area G32 are displayed in the center portion of the operation screen.

Text data subjected to searching by a user is displayed in the specific information operation area G31. The text data may include email text. In FIG. 14, part of text data is displayed in the specific information operation area G31. The attribute icons Z31 to Z33 indicating the predetermined attributes via the search application app4 are displayed in the attribute operation area G32. As the attributes of the attribute icons Z31 to Z33, types of search processes which can be executed via the search application app4 are determined in advance. Specifically, the attribute icon Z31 indicates the attribute “text”, i.e. an operation icon to execute a process of searching text information, connected to specific information, among text data subjected to searching. The attribute icon Z32 indicates the attribute “similar”, i.e. an operation icon to execute a process of searching similar information, connected to specific information, among text data subjected to searching. The attribute icon Z33 indicates the attribute “image”, i.e. an operation icon to execute a process of searching image information, connected to specific information, among text data subjected to searching.

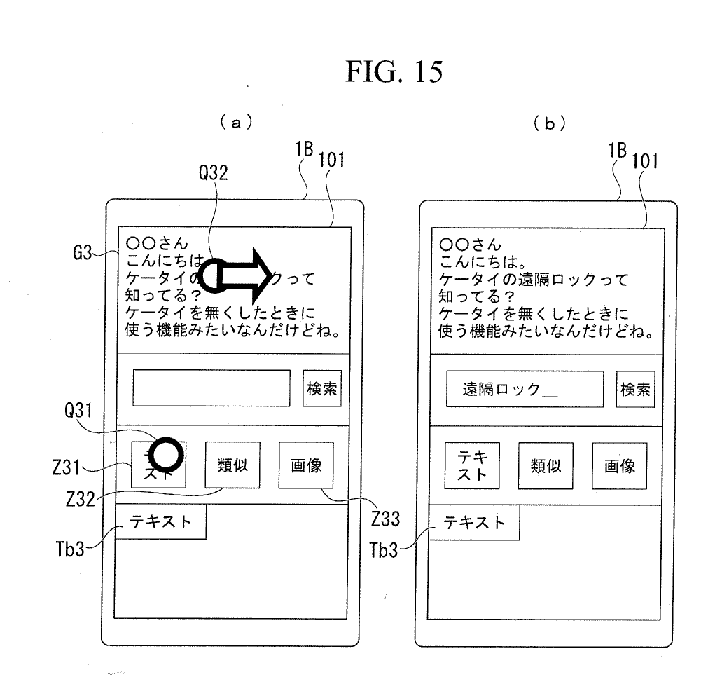

Next, the operation and the procedure in which a user executes a search process will be described with reference to FIG. 15. As shown in FIG. 15(a), the information reception screen G3 is displayed on the operation screen of the touch panel 101, wherein, when a user touches the attribute icon Z31 with a user's finger, the operation content determination part 121 detects a user's touch operation, and therefore the display control part 122 displays the finger icon superimposed on the attribute icon Z31. That is, the finger icon Q31 is displayed at the position of detecting a user's touch operation. Specifically, a use touches the attribute icon Z31 with a thumb of a user's right hand while maintaining a user's touch operation. Thus, the attribute setting part 1241 of the controller 102 sets the attribute “text” indicated by the attribute icon Z31 as the attribute connected to the specific information based on the determination result of the operation content determination part 121. The attribute setting part 1241 stores the attribute information representing the currently set attribute “text” in the temporary store area 134. The display control part 122 displays a tab Tb3 indicating the attribute “text” in the upper-left portion of the search result display area G34.

When a user carries out a touch slide operation on a character string “remote lock” displayed in the specific information operation area G31 with an index finger (or a middle finger) of a user's right hand while maintaining a touch operation on the attribute icon Z31 with a thumb of a user's right hand, for example, the operation content determination part 121 detects a user's touch slide operation, and therefore the display control part 122 displays a finger icon Q32 superposed on the character string “remote lock”. As show in FIG. 15(a), the display control part 122 moves the finger icon Q32 in a moving direction of a user's finger via a user's touch slide operation. Thus, the information acquisition part 124 of the controller 102 acquires the specific information, i.e. the character string “remote lock” corresponding to the display object area which is specified via a user's touch slide operation, based on the determination result of the operation content determination part 121. At this time, the display control part 122 may display an animation image superposed on the information reception screen G3 when the character string “remote lock” is being moved from the specific information operation area G31 to the input operation area G33. Herein, it is possible to adopt the animation image shown in FIG. 8. As shown in FIG. 15(b), the display control part 122 displays the character string “remote lock”, which is acquired as specific information by a user, in the input field of the input operation area G33.

As described above, when the specific information “remote lock” is retrieved from the display object area on the condition that a user has set the attribute “text”, the information management part 125 outputs the specific information “remote lock” to the application processing part 126 in connection with the attribute “text”. The application processing part 126 executes a search process to acquire the text information connected to the specific information “remote lock” from the searching information stored in the store part 103 or the searching information stored in the external server 5. For example, the application processing part 126 obtains the search result, i.e. the site information explaining the meaning of the specific information “remote lock” or the text data including the specific information “remote lock” retrieved from the searching information. The display control part 122 displays the search result, which is obtained via the search process of the application processing part 126, in the search result display area 34.

The portable terminal 1B of the third embodiment, in which a user has set the attribute “text”, is able to execute a search process (or text searching) corresponding to the type of a search process indicated by the attribute “text” when the specific information “remote lock” is obtained from the display object area. That is, the portable terminal 1B is able to execute a process corresponding to the type of an attribute, which is set by a user, with respect to a subject of processing (i.e. a display object) which is acquired as specific information. It is possible for a user to execute a process corresponding to the type of an attribute by specifying an attribute icon and a display object which are displayed on the operation screen. Therefore, it is possible to improve the usability, and it is possible for a user to execute a process corresponding to an attribute based on the desired specific information by intuitively operating the portable terminal 1B.

### Fourth Embodiment

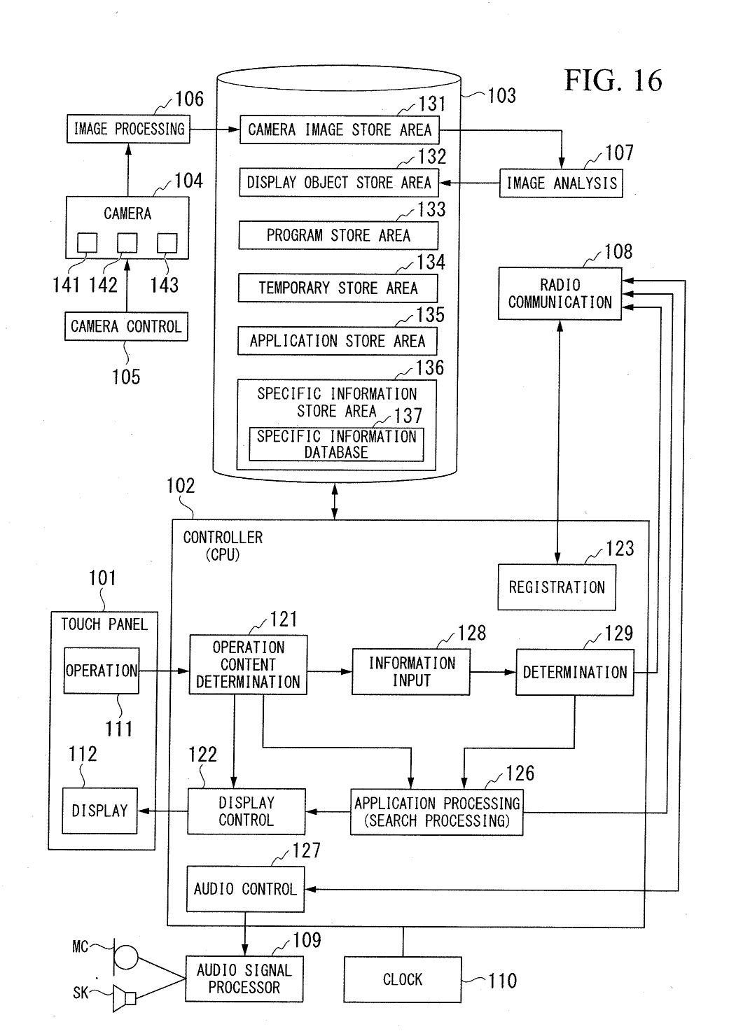

Next, a portable terminal 1C according to the fourth embodiment of the present invention will be described. FIG. 16 is a block diagram showing the configuration of the portable terminal 1C. In FIG. 16, parts identical to those of FIG. 2 are denoted using the same reference signs; hence, the descriptions there of will be omitted. The portable terminal 1C of the fourth embodiment includes an information input part 128 and a determination part which is substituted for the information acquisition part 124 and the information management part 125 included in the portable terminal 1 of the first embodiment. Additionally, a search application app5 is stored in the application store area 135 of the store part 103. Text data which is subjected to searching via the search application app5 is stored in the display object store area 132 of the store part 103.

When a user specifies part of text data subjected to searching while specifying an entry field which is displayed on the operation screen of the touch panel 101, the information input part 128 receives part of text data as specific information. That is, the information input part 128 inputs the specific information serving as the input information on which the program of the search application app5 will be executed. The determination part 129 determines the type of the specific information received with the information input part 128 so as to output the determination result to the application processing part 126. The determination part 129 determines as to whether the input specific information matches text data or image data.

The application processing part 126 reads and executes the program of the search application app5 stored in the application store area 135 of the store part 103 based on the determination result of the operation content determination part 121. In the portable terminal 1C of the fourth embodiment, the application processing part 126 implements the function of a search processing part. The application processing part 126 executes the predetermined type of a search process based on the determination result of the determination part 129. For example, when the determination part 129 determines that the specific information matches text data, the application processing part 126 searches the text information connected to the specific information from the searching information. When the determination part 129 determines that the specific information matches image data, the application processing part 126 searches the image information connected to the specific information from the searching information.

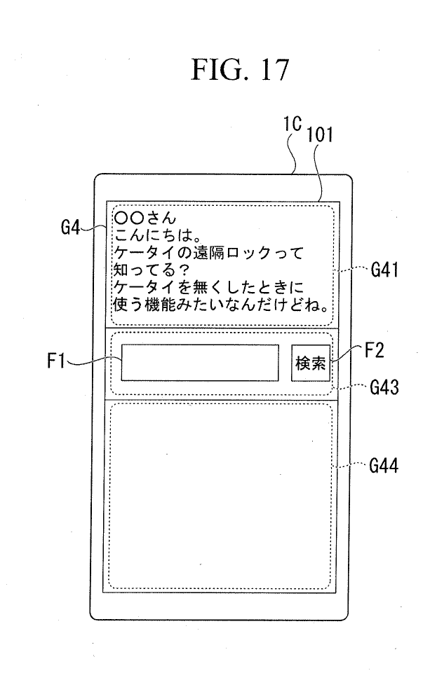

FIG. 17 shows an information reception screen G4 which is displayed on the touch panel 101 during execution of the search application app5. When the controller reads text data subjected to searching from the display object store area 132 of the store part 103 on the condition that the portable terminal 1C executes the program of the search application app5, the information reception screen G4 is displayed on the operation screen of the touch panel 101.

As shown in FIG. 17, the information reception screen G4 includes a specific information operation area G41 which is used to display text data subjected to searching, an input operation area G43 which is used to receive specific information which is specified by a user among text data subjected to searching, and a search result display area G44 which is used to display the search result of a search process based on the specific information which is input to the input operation area G43 via execution of the program of the search application app5. The specific information operation area G41 is displayed in the upper portion of the operation screen while the search result display area G44 is displayed in the lower portion of the operation screen. Additionally, the input operation area G43 is displayed at the intermediate position between the specific information operation area G41 and the search result display area G44. Text data subjected to searching is displayed in the specific information operation area G41. Text data may include email messages. In FIG. 17, an image displayed in the specific information operation area G41 forms part of text data. The input operation area 43 includes an entry field F1 which is used to input specific information serving as a search key in a search process, and a search icon F2 which is used to execute the search process based on the specific information of the entry field F1.

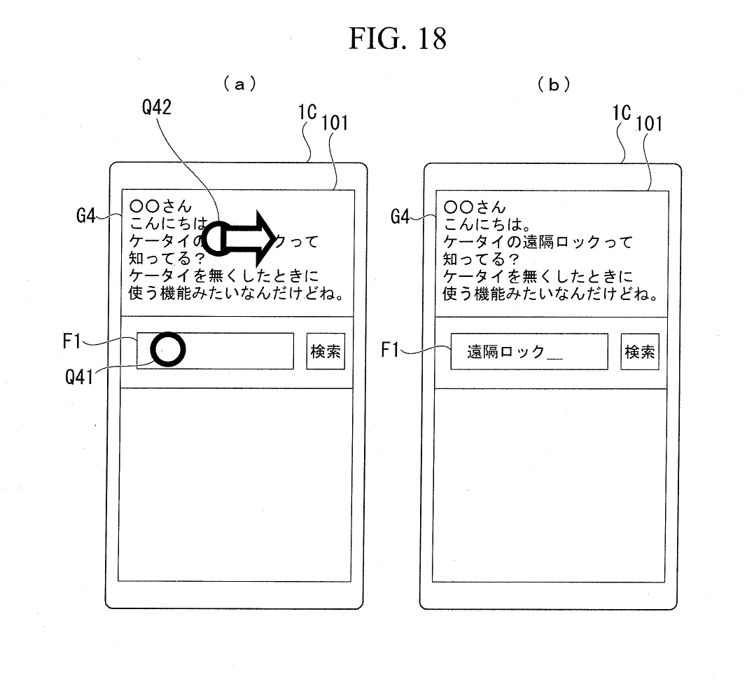

Next, the operation and the procedure which are needed to execute a search process will be described with reference to FIG. 18. As shown in FIG. 18(a), when a user touches the entry field F1 of the input operation area G43 on the condition that the information reception screen G4 is displayed on the operation screen of the touch panel 101, the operation content determination part 121 detects a user's touch operation, and therefore the display control part 122 displays a finger icon Q41 superposed on the input field F1. That is, the finger icon Q41 is displayed at the position of detecting a user's touch operation. Specifically, a user touches the entry field F1 with a thumb of a user's right hand while maintaining a touch operation.

When a user carries out a touch slide operation on a character string “remote lock”, which is displayed in the specific information operation area G41, with an index finger (or a middle finger) of a user's right hand while touching the entry field F1 with a thumb of a user's right hand, the operation content determination part 121 detects the touch slide operation, and therefore the display control part 122 displays a finger icon Q42 superposed on the character string “remote lock”. As shown in FIG. 18(a), the display control part 122 moves the finger icon Q42 in a moving direction via a user's touch slide operation. Thus, the information input part 128 of the controller 102 receives the character string “remote lock”, which is connected to the display object area specified via a user's touch slide operation, based on the determination result of the operation content determination part 121. That is, the information input part 128 inputs specific information, i.e. the character string “remote lock” serving as part of text data, subjected to searching, which is specified by a user.

At this time, the display control part 122 may display an animation image superposed on the information reception screen G4 when the character string “remote lock” is being moved from the specific information operation area G41 to the entry field F1 of the input operation area G43. Herein, it is possible to adopt the animation image shown in FIG. 8. As shown in FIG. 18(b), the display control part 122 displays the character string “remote lock”, which is retrieved as specific information by a user, in the entry field F1 of the input operation area G43.

As described above, when a user retrieves the specific information “remote lock” from the display object area by use of the entry field F1, the information input part 128 outputs the specific information “remote lock” to the application processing part 126. Based on the specific information “remote lock”, the application processing part 126 executes a search process to retrieve text information or image information, which is connected to the specific information “remote lock”, from the searching information stored in the store part 103 or the searching information stored in the external server 5. For example, the application processing part 126 obtains the search result, such as text data including the specific information “remote lock” or site information explaining the meaning of the specific information “remote lock”, from the searching information. The display control part 122 displays the search result, which is obtained via a search process of the application processing part 126, in the search result display area G44.

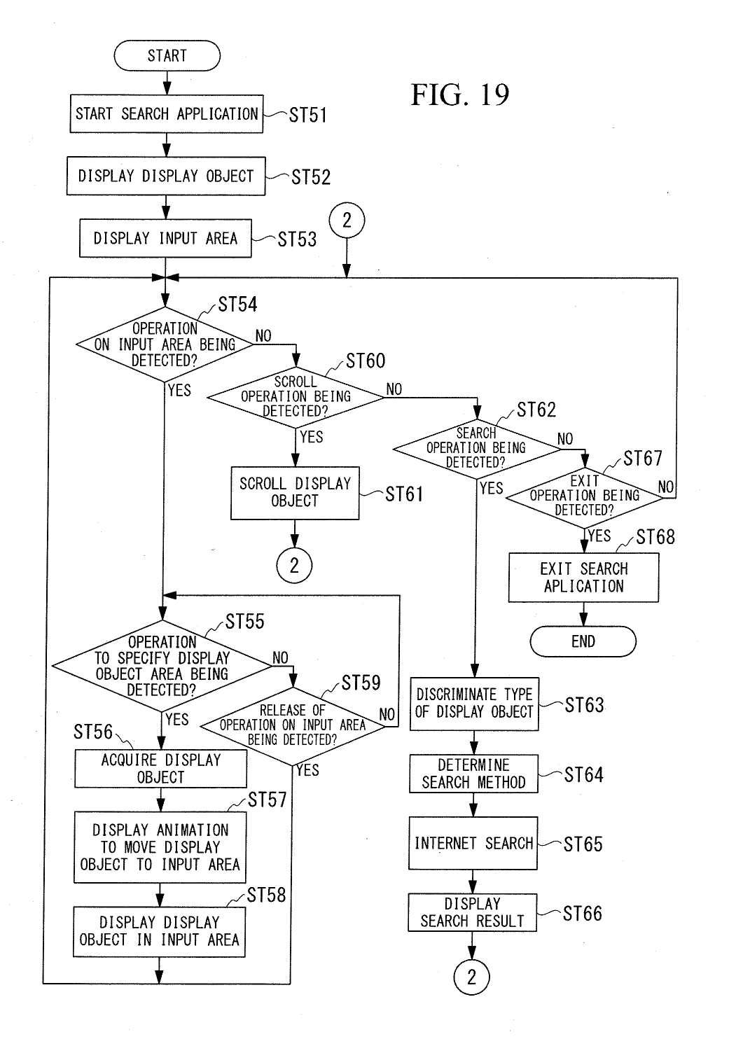

Next, the basic process of the portable terminal 1C of the fourth embodiment will be described with reference to FIG. 19.

### (Step ST51)

First, a user operates the operation part 111 of the touch panel 101 so as to start the search application app5. The application processing part 126 of the controller 102 of the portable terminal 1C reads and executes the program of the search application app5 from the application store area 135.

### (Step ST52)

The application processing part 126 reads text data subjected to searching from the display object store area 132 of the store part 103 in accordance with the search application app5, thus displaying the information reception screen G4 shown in FIG. 17 on the display 112 of the touch panel 101. That is, the display control part 122 displays the read text data in the specific information operation area G41 within the information reception screen G4. The text data subjected to searching is specified by a user among a plurality of text data which is stored in the display object display area 132.

### (Step ST53)

The display control part 122 displays the entry field F1 and the search icon F2 in the input operation area 43 within the information reception screen G4. Additionally, the display control part 122 displays the search result display area G44 in the information reception screen G4.

### (Step ST54)

The information reception screen G4 shown in FIG. 17 is displayed on the operation screen of the touch panel 101. The operation content determination part 121 determines as to whether or not a user touches the entry field F1 based on the detection result of the operation part 111 of the touch panel 101. When the operation content determination part 121 detects a user's touch operation, the display control part 122 displays the finger icon Q41 superposed on the entry field F1 of the information reception screen G4.

### (Step ST55)

The operation content determination part 121 determines as to whether or not a user carries out a touch slide operation on the display object area of the specific information operation area G41 based on the detection result of the operation part 111 of the touch panel 101. When the operation content determination part 121 detects a user's touch slide operation, the display control part 122 displays the finger icon Q42 at the touch position of a user's finger such that the finger icon Q42 is superposed on the specific information operation area G41 of the information reception screen G4.

### (Step ST56)

The information input part 128 inputs a display object specified by a user. That is, the information input part 128 obtains the specific information “remote lock” from the text data in the display object area which is specified via a user's touch slide operation.

### (Step ST57)

The display control part 122 displays an animation image superimposed on the information reception screen G4 when the specific information “remote lock” is being moved from the specific information operation area G41 to the entry field F1 of the input operation area G43. Herein, the specific information “remote lock” is gradually enlarged, and then it is gradually reduced in size as it is moved from the specific information operation area G41 to the input operation area G43.

### (Step ST58)

The display control part 122 displays the entry field F1 in the input operation area G43.

### (Step ST59)

When a user's touch slide operation is not detected in step ST55, the operation content determination part 121 determines as to whether or not a user's finger is separated from the entry field F1 so as to release a touch operation. The operation content determination part 121 repeats a decision as to whether or not a touch slide operation is detected until a user's touch operation is released. When a user's touch operation is released, the flow returns to step ST54.

### (Step ST60)

When a user's touch operation on the entry field F1 is not detected in step ST54, the operation content determination part 121 determines as to whether or not a user's scroll operation is detected.

### (Step ST61)

When the operation content determination part 121 detects a user's scroll operation, the display control part 122 scrolls the picture of the information reception screen G4, which is displayed on the display part 112 of the touch panel 101, in a direction specified by a user. Thus, it is possible to change text data displayed in the specific information operation area G41 and to display an image outside the specific information operation area G41.

### (Step ST62)

When a user's scroll operation is not detected in step ST60, the operation content determination part 121 determines as to whether or not a user touches the search icon F2 based on the detection result of the operation part 111 of the touch panel 101.

### (Step ST63)

Upon detecting a user's touch operation on the search icon F2, the determination part 129 determines the type of the specific information which is received with the information input part 128, thus outputting the determination result to the application processing part 126. Since the specific information “remote lock” is text data, the type of the specific information representing the text data is output to the application processing part 126.

### (Step ST64)

The application processing part 126 determines the type of a search process (i.e. a search method) based on the determination result of the determination part 129. Herein, the application processing part 126 determines to execute text searching based on the type of text data. Additionally, the application processing part 126 determines to execute a search method (e.g. a search method via the Internet) which is determined as a text searching method in advance.

### (Step ST65)

The application processing part 126 transmits a request to execute a search process using a search key representing the specific information “remote lock” with the server 5, which is connected to the Internet 4, via the radio communication part 108.

### (Step ST66)

Thereafter, the radio communication part 108 receives the search result from the server 5 via the Internet 4 so as to output it to the application processing part 126. The application processing part 126 instructs the display control part 122 to display the search result in the search result display area G44. Thus, it is possible to display the search result in the search result display area G44.

### (Step ST67)

When it is detected that a user's touch operation on the search icon F2 is not carried out within a certain period of time in step ST62, the operation content determination part 121 determines whether or not to exit the search application app5 based on the detection result of the operation part 111 of the touch panel 101.

### (Step ST68)

When a user operates the operation part 111 of the touch panel 101 so as to exit the search application app5, the controller 102 terminates execution of the application program.

When a user obtains the specific information “remote lock” from the display object area in the portable terminal 1C of the fourth embodiment in which the entry field F1 is specified by a user, the controller 102 executes a search process on the specific information “remote lock”. That is, it is possible for a user to execute the type of a process suited to a desired attribute by specifying an attribute icon and a display object which are displayed on the operation screen. Thus, it is possible to the usability, and it is possible for a user to intuitively operate the portable terminal 1C so as to execute a process suited to an attribute based on the desired specific information.

The present invention is not necessarily limited to the first to fourth embodiments. The portable radio terminal 1 of the foregoing embodiments (or portable terminals 1A, 1B, 1C) incorporates the operation part 111 and the display part 112 in the touch panel 101; but this is not a restriction. For example, it is possible to replace the display 112 of the portable terminal 1 with a display not having a touch panel while using an operation means, such as a mouse, a keyboard, and a switch, as the operation part 111. Additionally, it is possible to aggregate the personal finance information acquisition application app1 and the personal finance management application app2 adapted to the portable terminal 1 of the first embodiment into a single application which is executable via the same program. Alternatively, the personal finance information acquisition application app1 may be implemented as a program pre-installed in the portable terminal 1.

In the portable terminal 1 of the foregoing embodiments, a user may visually recognize a user's touch operation via a finger icon which is displayed at the touch position of a user's finger on the touch panel 101; but this is not a restriction. For example, it is possible to omit a finger icon indicating the touch position of a user's finger (or the proximate position) on the touch panel 101 while omitting icons which are displayed to indicate a user's touch slide operation and a user's flick operation. Thus, it is possible to reduce the processing load of display control. Alternatively, it is possible to implement visual effect processes on the operation screen by adding meshing (or hatching) or semi-transparent colors to the user's specified display object area or text data and schematic data included in the display object area or by changing colors of characters or colors of figures without displaying finger icons.

The portable terminal 1 of the foregoing embodiment is an example of the information processing device of the present invention; hence, it includes a computer system therein. Thus, it is possible to store programs implementing the foregoing operation and procedure in computer-readable storage media. In this case, the computer system may implement the foregoing operation and procedure by reading and executing programs from the storage media. In this connection, the “computer system” may embrace the software such as OS (Operating System) as well as the hardware such as a CPU, memory, and peripheral devices. The “computer system” using the WWW system may embrace home page providing environments (or home page displaying environments).

It is possible to store programs, implementing the steps of the foregoing flowcharts, in computer-readable storage media. Additionally, it is possible to store programs, implementing the functions of the foregoing embodiments, in computer-readable storage media. In this case, it is possible to calculate the estimated values regarding the shapes of the detected objects (e.g. user's fingers and stylus pens) by executing programs loaded into the computer system. In this connection, the “computer-readable storage media” refer to flexible disks, magneto-optical disks, ROM, non-volatile rewritable memory such as flash memory, portable media such as CD-ROM, and hard-disk units incorporated into computer systems.

The “computer-readable storage media” may embrace any storage means which can store programs for a certain period of time, such as non-volatile memory (e.g. DRAM) included in computer systems serving as servers or clients which are able to transmit programs via telephone lines, communication lines, or networks such as the Internet. It is possible to store the foregoing programs in a storage device of a computer system and then to transmit them to other computer systems via transmission media or transmission waves propagating in transmission media. The “transmission media” which are used to transmit the foregoing programs refer to any media having information transmitting functions such as telephone lines, communication lines, and networks (or communication networks) such as the Internet. Additionally, the foregoing programs may implement part of the foregoing functions. Moreover, it is possible to draft the foregoing programs as differential files (or differential programs) which are combined with programs pre-installed in computer systems.

### INDUSTRIAL APPLICABILITY

The present invention is applicable to information processing devices such as portable terminals and smart phones so as to input desired images, carry out a process to analyze their contents, and thereby carry out editing and searching processes with high usability. In particular, it is possible to carry out editing and searching processes on specific information connected to desired attributes retrieved from images input to portable terminals with simple user's operations. In the present invention, each user does not need to remember complicated procedures; hence, each user may easily input images, carry out an analysis process, editing and searching processes via intuitive operations. Thus, the present invention can be widely applied to information processing devices having touch panels.

### REFERENCE SIGNS LIST

1, 1A, 1B, 1C portable terminal
101 touch panel
102 controller
103 store part
104 camera
105 camera control part
106 image processing part
107 image analysis part
108 radio communication part
109 audio signal processor
110 clock
111 operation part
112 display
121 operation content determination part
122 display control part
123 registration part
124 information acquisition part
125 information management part
126 application processing part
127 audio control part
128 information input part
129 determination part
131 camera image store area
132 display object store area
133 program store area
134 temporary store area
135 application store area
136 specific information store area
137 specific information database
1241 attribute setting part
1242 specific information acquisition part

1. An information processing device having a touch panel, comprising:
a display which displays an operation screen;
an operation part which receives a user's operation on the operation screen;
an information acquisition part which acquires specific information from a display object area on the operation screen; and
an information management part which manages the specific information in connection with a desired attribute which is set by a user in advance.

2. The information processing device according to claim 1, further comprising:
a display control part which displays a specific information operation area, which receives a user's operation specifying desired specific information, and an attribute operation area, which receives a user's operation specifying a desired attribute, on the operation screen; and
an operation content determination part which determines a content of the user's operation based on a detection result of the user's operation on the operation screen with the operation part,
wherein the information management part manages the specific information of the specific information operation area in connection with the attribute of the attribute operation area when the desired specific information is specified by the user's operation on the specific information operation area while the desired attribute is set by the user's operation on the attribute operation area.

3. The information processing device according to claim 2, wherein the display control part controls the display to display on the operation screen a capture data display area which posts the specific information acquired by the information acquisition part, and wherein the display control part controls the display to display on the operation screen an animation image showing that the specific information is moved from the specific information operation area to the capture data display area.

4. The information processing device according to claim 1, further comprising an application processing part which executes an application program, which is started by a user, so as to carry out a process suited to the attribute on the specific information.

5. The information processing device according to claim 4, wherein an item of payment corresponding to the attribute and a payment corresponding to the specific information are displayed in the display object area of the operation screen in accordance with a personal finance management application program which is executed by the application processing part, and wherein the information management part manages the payment, which is acquired as the specific information by the information acquisition part, in connection with the item of payment which is set as the attribute.

6. The information processing device according to claim 4, wherein the information management part manages the specific information acquired by the information acquisition part in connection with an attribute representing a type of a process which is executed by the application processing part.

7. The information processing device according to claim 6, wherein the application processing part executes a text editing application program so as to set an attribute representing a text editing item, and wherein text data, which is acquired as the specific information by the information acquisition part, is edited with respect to the text editing item.

8. The information processing device according to claim 7, wherein the text editing item represents at least one of a text data format, a character shape, a font, a character color, a character size, and a rotation angle.

9. The information processing device according to claim 7, wherein the application processing part temporarily stores the specific information representing part of the text data in accordance with the text editing application program.

10. The information processing device according to claim 7, wherein the information acquisition part acquires the specific information representing character information or schematic information which is included in the display object area on the operation screen.

11. An information processing device having a touch panel, comprising:
a display which displays the operation screen;
an operation part which receives a user's operation on the operation screen;
a display control part which controls the display to display on the operation screen a specific information operation area, which receives a user's operation to specify desired specific information, an input operation area, which receives a user's operation to input information, and an attribute operation area which receives a user's operation to set a desired attribute;
an operation content determination part which determines a content of the user's operation based on a detection result of the user's operation on the operation screen with the operation part; and
an information input part which posts the specific information in the input operation area when the desired specific information is specified via the user's operation in the specific information operation area while the user's operation to input information is applied to the input operation area.

12. The information processing device according to claim 11, further comprising a search processing part which executes a search process on searching information displayed in the specific information operation area by use of a search key representing the specific information.

13. The information processing device according to claim 12, further comprising a determination part which determines a type of the searching information displayed in the specific information operation area, wherein the search processing part executes the search process on the searching information based on a determination result of the determination part.

14. An information processing method adapted to an information processing device having a touch panel, comprising:
receiving a user's operation on an operation screen which is displayed on the touch panel;
acquiring specific information from a display object area on the operation screen; and
when a desired attribute is set by a user in advance, managing the specific information in connection with the attribute.

15. A computer-readable storage medium implementing an information processing method adapted to a computer achieving an information processing function interacting with a user's operation, the information processing method comprising:
receiving a user's operation on an operation screen;
acquiring specific information from a display object area on the operation screen; and
when a desired attribute is set by a user in advance, managing the specific information in connection with the attribute.
